(19) United States
(12) Patent Application Publication
(10) Pub. No.: US 2025/0342613 A1
(43) Pub. Date: Nov. 6, 2025

(54) NEURAL-NETWORK POST-FILTER PURPOSES WITH PICTURE RATE UPSAMPLING

(71) Applicants: Douyin Vision Co., Ltd., Beijing (CN); Bytedance Inc., Los Angeles, CA (US)

(72) Inventors: Ye-Kui Wang, San Diego, CA (US); Jizheng Xu, San Diego, CA (US); Li Zhang, San Diego, CA (US); Kai Zhang, San Diego, CA (US); Yue Li, San Diego, CA (US); Junru Li, Beijing (CN); Chaoyi Lin, Beijing (CN)

(21) Appl. No.: 19/268,764

(22) Filed: Jul. 14, 2025

Related U.S. Application Data
(63) Continuation of application No. PCT/CN2024/072271, filed on Jan. 15, 2024.

(30) Foreign Application Priority Data
Jan. 16, 2023 (WO) PCT/CN2023/072367

(51) Int. Cl. G06T 9/00; H04N 19/117; H04N 19/184; H04N 19/70

(52) U.S. Cl. CPC G06T 9/002; H04N 19/117; H04N 19/184; H04N 19/70

(57) ABSTRACT

A mechanism for processing video data is disclosed. The mechanism includes determining a neural-network post-filter (NNPF) purpose based on a neural-network post-filter characteristics (NNPFC) supplemental enhancement information (SEI) message. A conversion is performed between a visual media data and a bitstream based on the NNPF purpose. Multiple input pictures are used for the NNPF purpose, and the NNPF is enabled to selectively generate output pictures for some input picture(s) and not to generate output pictures for other input picture(s).

### CROSS-REFERENCE TO RELATED APPLICATIONS

This application is a continuation of International Patent Application No. PCT/CN2024/072271, filed on Jan. 15, 2024, which claims the priority to and benefits of International Patent Application No. PCT/CN2023/072367, filed on Jan. 16, 2023, both of which are herein incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining a neural-network post-filter (NNPF) purpose based on a neural-network post-filter characteristics (NNPFC) supplemental enhancement information (SEI) message; and performing a conversion between a visual media data and a bitstream based on the NNPF purpose.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining a neural-network post-filter (NNPF) purpose based on a neural-network post-filter characteristics (NNPFC) supplemental enhancement information (SEI) message; and generating a bitstream based on the determining.

A fifth aspect relates to a method for storing bitstream of a video comprising: determining a neural-network post-filter (NNPF) purpose based on a neural-network post-filter characteristics (NNPFC) supplemental enhancement information (SEI) message; generating a bitstream based on the determining; and storing the bitstream in a non-transitory computer-readable recording medium.

A sixth aspect relates to a method, apparatus or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of deriving luma channels from a luma component.

FIG. 2 is a block diagram showing an example video processing system.

FIG. 3 is a block diagram of an example video processing apparatus.

FIG. 4 is a flowchart for an example method of video processing.

FIG. 5 is a block diagram that illustrates an example video coding system.

FIG. 6 is a block diagram that illustrates an example encoder.

FIG. 7 is a block diagram that illustrates an example decoder.

FIG. 8 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and embodiments illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, H.266 terminology is used in some description only for ease of understanding and not for limiting scope of the disclosed embodiments. As such, the embodiments described herein are applicable to other video codec protocols and designs also. In the present disclosure, editing changes are shown to text by triple brackets indicating cancelled text (i.e., [[[a]]] indicates that ‘a’ is deleted) and double braces indicating added text (i.e., {{a}} indicates that ‘a’ is added), with respect to the Versatile Video Coding (VVC) specification and/or the International Organization for Standardization (ISO) base media file format (ISOBMFF) standard.

### 1. Initial Discussion

This disclosure is related to image/video coding technologies. Specifically, this disclosure is related to the definition and signaling of neural-network post-filter (NNPF) purposes with picture rate upsampling and other types of upsampling, more efficient signaling of the number of interpolated pictures, the order of multiple types of upsampling, and the number of input pictures for any NNPF purpose. The ideas may be applied individually or in various combinations, for video bitstreams coded by any codec, e.g., the versatile video coding (VVC) standard and/or the versatile supplemental enhancement information (SEI) messages for coded video bitstreams (VSEI) standard.

### 2. Abbreviations

The following abbreviations may be used in the present disclosure: adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), picture unit (PU), random access skipped leading (RASL) picture, supplemental enhancement information (SEI), step-wise temporal sublayer access (STSA), video coding layer (VCL), versatile supplemental enhancement information as described in Rec. ITU-T H.274 ISO/IEC 23002-7 (VSEI), video usability information (VUI), versatile video coding as described in Rec. ITU-T H.266 ISO/IEC 23090-3 (VVC).

### 3. Further Discussion

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is a coding standard targeting a 50% bitrate reduction as compared to HEVC.

The Versatile Video Coding (VVC) standard (ITU-T H.266 ISO/IEC 23090-3) [3] and the associated Versatile Supplemental Enhancement Information for coded video bitstreams (VSEI) standard (ITU-T H.274 ISO/IEC 23002-7) [4] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard under development by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for checking bitstream conformance.

Annex D of VVC specifies syntax and semantics for SEI message payloads for some SE messages, and specifies the use of the SEI messages and VUJ parameters for which the syntax and semantics are specified in JTU-T H.274|ISO/IEC 23002-7.

### 3.3 Signalling of Neural-Network Post-Filters

WG 05 output document N0158 [5] and JVET-AB2006 [6] include the specification of two SEI messages for signalling of neural-network post-filters, as follows.

### 8.28 Neural-Network Post-Filter Characteristics SEI Message

### 8.28.1 Neural-Network Post-Filter Characteristics SEI Message Syntax

| | Descriptor |
|---|---|
| nn_post_filter_characteristics( payloadSize ) { | |
| {{nnpfc_id}} | ue(v) |
| {{nnpfc_mode_idc}} | ue(v) |
| if( nnpfc_mode_idc = = 1 ) { | |
| while( !byte_aligned( ) ) | |
| {{nnpfc_reserved_zero_bit_a | u(1) |
| nnpfc_tag_uri | st(v) |
| nnpfc_uri}} | st(v) |
| } | |
| {{nnpfc_formatting_and_purpose_flag}} | u(1) |
| if( nnpfc_formatting_and_purpose_flag ) { | |
| {{nnpfc_purpose}} | ue(v) |
| /* input and output formatting */ | |
| if( nnpfc_purpose = = 2 \| \| nnpfc_purpose = = 4 ) | |
| {{nnpfc_out_sub_c_flag}} | u(1) |
| else if( nnpfc_purpose = = 3 \| \| nnpfc_purpose = = 4 ) { | |
| {{nnpfc_pic_width_in_luma_samples}} | ue(v) |
| {{nnpfc_pic_height_in_luma_samples}} | ue(v) |
| } | |
| else if( nnpfc_purpose = = 5 ) { | |
| {{nnpfc_num_input_pics_minus2}} | ue(v) |
| for( i = 0; i <= nnpfc_num_input_pics_minus2; | |
| i++ ) | |
| {{nnpfc_interpolated_pics[ i ]}} | ue(v) |
| } | |
| {{nnpfc_component_last_flag}} | u(1) |
| {{nnpfc_inp_format_idc}} | ue(v) |
| if( nnpfc_inp_format_idc = = 1 ) | |
| {{nnpfc_inp_tensor_bitdepth_minus8 | ue(v) |
| nnpfc_inp_order_idc | ue(v) |
| nnpfc_auxiliary_inp_idc | ue(v) |
| nnpfc_separate_colour_description_present_flag}} | u(1) |
| if( nnpfc_separate_colour_description_present_flag | |
| ) { | |
| {{nnpfc_colour_primaries | u(8) |
| nnpfc_transfer_characteristics | u(8) |
| nnpfc_matrix_coeffs}} | u(8) |
| } | |
| {{nnpfc_out_format_idc}} | ue(v) |
| if( nnpfc_out_format_idc = = 1 ) | |
| {{nnpfc_out_tensor_bitdepth_minus8 | ue(v) |
| nnpfc_out_order_idc | ue(v) |
| nnpfc_constant_patch_size_flag | u(1) |
| nnpfc_patch_width_minus1 | ue(v) |
| nnpfc_patch_height_minus1 | ue(v) |
| nnpfc_overlap | ue(v) |
| nnpfc_padding_type}} | ue(v) |
| if( nnpfc_padding_type = = 4 ) { | |
| {{nnpfc_luma_padding_val | ue(v) |
| nnpfc_cb_padding_val | ue(v) |
| nnpfc_cr_padding_val}} | ue(v) |
| } | |
| {{nnpfc_complexity_info_present_flag}} | ue(v) |
| if( nnpfc_complexity_info_present_flag ) { | |
| {{nnpfc_parameter_type_idc}} | u(2) |
| if( nnpfc_parameter_type_idc != 2 ) | |
| {{nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size}} | ue(v) |
| } | |
| } | |
| /* ISO/IEC 15938-17 bitstream */ | |
| if( nnpfc_mode_idc = = 0 ) { | |
| while( !byte_aligned( ) ) | |
| {{nnpfc_reserved_zero_bit_b}} | u(1) |
| for( i = 0; more_data_in_payload( ); i++ ) | |
| {{nnpfc_payload_byte[ i ]}} | b(8) |
| } | |
| } | |

### 8.28.2 Neural-Network Post-Filter Characteristics SEI Message Semantics

The neural-network post-filter characteristics (NNPFC) SEI message specifies a neural network that may be used as a post-processing filter. The use of specified post-processing filters for specific pictures is indicated with neural-network post-filter activation SEI messages.

Use of this SEI message requires the definition of the following variables:
Cropped decoded output picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the cropped decoded output pictures with idx in the range of 0 to numInputPics-1, inclusive, that are used as input for the post-processing filter.
Bit depth BitDepthY for the luma sample array of the cropped decoded output pictures.
Bit depth BitDepthC for the chroma sample arrays, if any, of the cropped decoded output pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

The variables SubWidthC and SubHeightC are derived from ChromaFormatIdc as specified by Table 2. NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_id contains an identifying number that may be used to identify a post-processing filter. The value of nnpfc_id shall be in the range of 0 to 232-2, inclusive. Values of nnpfc_id from 256 to 511, inclusive, and from 231 to 232-2, inclusive, are reserved for future use by ITU-T ISO/IEC. Decoders conforming to this edition of this document encountering an NNPFC SEI message with nnpfc_id in the range of 256 to 511, inclusive, or in the range of 231 to 232-2, inclusive, shall ignore the SEI message.

When an NNPFC SEI message is the first NNPFC SEI message, in decoding order, that has a particular nnpfc_id value within the current CLVS, the following applies:
This SEI message specifies a base post-processing filter.
This SEI message pertains to the current decoded picture and all subsequent decoded pictures of the current layer, in output order, until the end of the current CLVS.

When an NNPFC SEI message is a repetition of a previous NNPFC SEI message, in decoding order, in the current CLVS, the subsequent semantics apply as if this SEI message were the only NNPFC SEI message having the same content within the current CLVS.

When an NNPFC SEI message is not the first NNPFC SEI message, in decoding order, that has a particular nnpfc_id value within the current CLVS, the following applies:
This SEI message defines an update relative to the preceding base post-processing filter in decoding order with the same nnpfc_id value.
This SEI message pertains to the current decoded picture and all subsequent decoded pictures of the current layer, in output order, until the end of the current CLVS or the next NNPFC SEI message having that particular nnpfc_id value, in output order, within the current CLVS.

nnpfc_mode_idc equal to 0 indicates that this SEI message contains an ISO/IEC 15938-17 bitstream that specifies a base post-processing filter or is an update relative to the base post-processing filter with the same nnpfc_id value.

When an NNPFC SEI message is the first NNPFC SEI message, in decoding order, that has a particular nnpfc_id value within the current CLVS, nnpfc_mode_idc equal to 1 specifies that the base post-processing filter associated with the nnpfc_id value is a neural network identified by the URI indicated by nnpfc_uri with the format identified by the tag URI nnpfc_tag_uri.

When an NNPFC SEI message is not the first NNPFC SEI message, in decoding order, that has a particular nnpfc_id value within the current CLVS, nnpfc_mode_idc equal to 1 specifies that an update relative to the base post-processing filter with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T|ISO/IEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

When this SEI message is the first NNPFC SEI message, in decoding order, that has a particular nnpfc_id value within the current CLVS, the post-processing filter PostProcessingFilter( ) is assigned to be the same as the base post-processing filter.

When this SEI message is not the first NNPFC SEI message, in decoding order, that has a particular nnpfc_id value within the current CLVS, a post-processing filter PostProcessingFilter( ) is obtained by applying the update defined by this SEI message to the base post-processing filter.

Updates are not cumulative but rather each update is applied on the base post-processing filter, which is the post-processing filter specified by the first NNPFC SEI message, in decoding order, that has a particular nnpfc_id value within the current CLVS.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in IETF RFC 4151 identifying the format and associated information about the neural network used as a base post-processing filter or an update relative to the base post-processing filter with the same nnpfc_id value specified by nnpfc_uri.

NOTE 2—nnpfc_tag_uri enables uniquely identifying the format of neural network data specified by nnrpf_uri without needing a central registration authority.

nnpfc_tag_uri equal to “tag:iso.org,2023:15938-17” indicates that the neural network data identified by nnpfc_uri conforms to ISO/IEC 15938-17.

nnpfc_uri contains a URI with syntax and semantics as specified in IETF Internet Standard 66 identifying the neural network used as a base post-processing filter or an update relative to the base post-processing filter with the same nnpfc_id value.

nnpfc_formatting_and_purpose_flag equal to 1 specifies that syntax elements related to the filter purpose, input formatting, output formatting, and complexity are present. nnpfc_formatting_and_purpose_flag equal to 0 specifies that no syntax elements related to the filter purpose, input formatting, output formatting, and complexity are present.

When this SEI message is the first NNPFC SEI message, in decoding order, that has a particular nnpfc_id value within the current CLVS, nnpfc_formatting_and_purpose_flag shall be equal to 1. When this SEI message is not the first NNPFC SEI message, in decoding order, that has a particular nnpfc_id value within the current CLVS, nnpfc_formatting_and_purpose_flag shall be equal to 0.

nnpfc_purpose indicates the purpose of the post-processing filter as specified in Table 20.

The value of nnpfc_purpose shall be in the range of 0 to 5, inclusive, in bitstreams conforming to this edition of this document. Values of 6 to 1023, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 6 to 1203, inclusive. Values of nnpfc_purpose greater than 1023 shall not be present in bitstreams conforming to this edition of this document and are not reserved for future use.

TABLE 20
Definition of nnpfc_purpose

| Value | Interpretation |
|---|---|
| 0 | May be used as determined by the application |
| 1 | Visual quality improvement |
| 2 | Chroma upsampling from the 4:2:0 chroma format to the |
| | 4:2:2 or 4:4:4 chroma format, or from the 4:2:2 chroma |
| | format to the 4:4:4 chroma format |
| 3 | Increasing the width or height of the cropped decoded |
| | output picture without changing the chroma format |
| 4 | Increasing the width or height of the cropped decoded |
| | output picture and upsampling the chroma format |
| 5 | Picture rate upsampling |

NOTE 3—When a reserved value of nnpfc_purpose is taken into use in the future by ITU-T|ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 or 4.

nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

nnpfc_num_input_pics_minus2 plus 2 specifies the number of decoded output pictures used as input for the post-processing filter.

nnpfc_interpolated_pics[i] specifies the number of interpolated pictures generated by the post-processing filter between the i-th and the (i+1)-th picture used as input for the post-processing filter.

The variables numInputPics, specifying the number of pictures used as input for the post-processing filter, and numOutputPics, specifying the total number of pictures resulting from the post-processing filter, are derived as follows:

| | |
|---|---|
| if( nnpfc_purpose = = 5 ) { | |
| numInputPics = nnpfc_num_input_pics_minus2 + 2 | |
| for( i = 0, numOutputPics = 0; i <= numInputPics − 2; i++ ) | (76) |
| numOutputPics += nnpfc_interpolated_pics[ i ] | |
| } else | |
| numInputPics = 1 | |

nnpfc_component_last_flag equal to 1 indicates that the last dimension in the input tensor inputTensor to the post-processing filter and the output tensor outputTensor resulting from the post-processing filter is used for a current channel. nnpfc_component_last_flag equal to 0 indicates that the third dimension in the input tensor inputTensor to the post-processing filter and the output tensor outputTensor resulting from the post-processing filter is used for a current channel.

NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.

NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the post-processing filter. When nnpfc_inp_format_idc is equal to 0, the input values to the post-processing filter are real numbers and the functions InpY( ) and InpC( ) are specified as follows:

$$InpY ( x ) = x \div ( ( 1 ≪ BitDepthY ) - 1 ) \qquad ( 77 )$$

$$InpC ( x ) = x \div ( ( 1 ≪ BitDepthC ) - 1 ) \qquad ( 78 )$$

When nnpfc_inp_format_idc is equal to 1, the input values to the post-processing filter are unsigned integer numbers and the functions InpY( ) and InpC( ) are specified as follows:

| | |
|---|---|
| shiftY = BitDepthY − inpTensorBitDepth | |
| if( inpTensorBitDepth >= BitDepthY) | |
| InpY(x) = x << ( inpTensorBitDepth − BitDepthY ) | (79) |
| else | |
| InpY( x ) = Clip3(0, ( 1 << inpTensorBitDepth ) − 1, ( x + ( | |
| 1 << ( shiftY − 1 ) ) ) >> shiftY ) | |
| shiftC = BitDepthC − inpTensorBitDepth | |
| if( inpTensorBitDepth >= BitDepthC ) | |
| InpC( x ) = x << ( inpTensorBitDepth − BitDepthC ) | (80) |
| else | |
| InpC( x ) = Clip3(0, ( 1 << inpTensorBitDepth ) − 1, ( x + ( | |
| 1 << ( shiftC − 1 ) ) ) >> shiftC ) | |

The variable inpTensorBitDepth is derived from the syntax element nnpfc_inp_tensor_bitdepth_minus8 as specified below.

Values of nnpfccinppformatidc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_inp_format_idc.

nnpfc_inptensor_bitdepth_minus8 plus 8 specifies the bit depth of luma sample values in the input integer tensor. The value of in TensorBitDeth is derived as follows:

$$inpTensorBitDepth = nnpfc\_inp \_tensor \_bitdepth \_minus 8 + 8 \qquad ( 81 )$$

It is a requirement of bitstream conformance that the value of nnpfc_inp_tensor_bitdepth_minus8 shall be in the range of 0 to 24, inclusive.

nnpfc_inp_order_idc indicates the method of ordering the sample arrays of a cropped decoded output picture as one of the input pictures to the post-processing filter.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

Table 21 contains an informative description of nnpfc_inp_order_idc values.

TABLE 21
Description of nnpfc_inp_order_idc values

| nnpfc_inp_{—} | |
|---|---|
| order_idc | Description |
| 0 | If nnpfc_auxiliary_inp_idc is equal to 0, one luma matrix is present in the input tensor for |
| | each input picture, and the number of channels is 1. Otherwise when |
| | nnpfc_auxiliary_inp_idc is equal to 1, one luma matrix and one auxiliary input matrix are |
| | present, and the number of channels is 2. |
| 1 | If nnpfc_auxiliary_inp_idc is equal to 0, two chroma matrices are present in the input tensor, |
| | and the number of channels is 2. Otherwise when nnpfc_auxiliary_inp_idc is equal to 1, two |
| | chroma matrices and one auxiliary input matrix are present, and the number of channels is 3. |
| 2 | If nnpfc_auxiliary_inp_idc is equal to 0, one luma and two chroma matrices are present in |
| | the input tensor, and the number of channels is 3. Otherwise when nnpfc_auxiliary_inp_idc |
| | is equal to 1, one luma matrix, two chroma matrices and one auxiliary input matrix are |
| | present, and the number of channels is 4. |
| 3 | If nnpfc_auxiliary_inp_idc is equal to 0, four luma matrices and two chroma matrices are |
| | present in the input tensor, and the number of channels is 6. Otherwise when |
| | nnpfc_auxiliary_inp_idc is equal to 1, four luma matrices, two chroma matrices, and one |
| | auxiliary input matrix are present in the input tensor, and the number of channels is 7. The |
| | luma channels are derived in an interleaved manner as illustrated in FIG. 12. This |
| | nnpfc_inp_order_idc can only be used when the chroma format is 4:2:0. |
| 4 . . . 255 | Reserved |

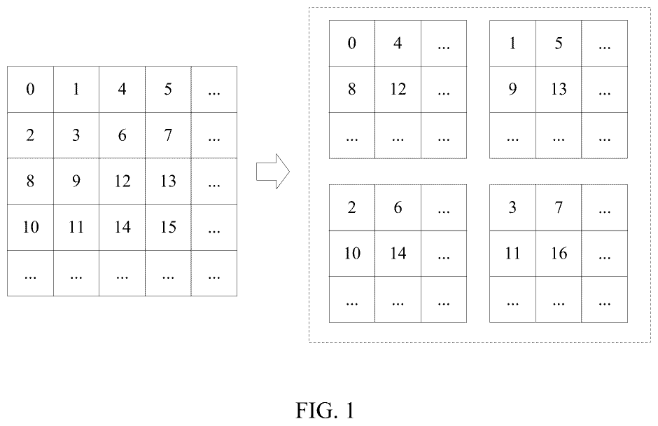

FIG. 1 illustrates an example of deriving luma channels from a luma component, for example when nnpfc_inp_order_idc is equal to 3.

A patch is a rectangular array of samples from a component (e.g., a luma or chroma component) of a picture.

nnpfc_auxiliary_inp_idc greater than 0 indicates that auxiliary input data is present in the input tensor of the neural-network post-filter. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 82.

The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

The process DeriveInputTensors( ), for deriving the input tensor inputTensor for a given vertical sample coordinate cTop and a horizontal sample coordinate cLeft specifying the top-left sample location for the patch of samples included in the input tensor, is specified as follows:

| | |
|---|---|
| for( i = 0; i < numInputPics; i++ ) { | |
| if( nnpfc_inp_order_idc = = 0) | |
| for( yP = −overlapSize; yP < inpPatchHeight + overlapSize; yP++) | |
| for( xP = −overlapSize; xP < inpPatchWidth + overlapSize; xP++ ) { | |
| inpVal = InpY( InpSampleVal( cTop + yP, cLeft + xP, CroppedHeight, | |
| CroppedWidth, CroppedYPic[ i ] ) ) | |
| if( !nnpfc_component_last_flag ) | |
| inputTensor[ 0 ][ i ][ 0 ][ yP + overlapSize ][ xP + overlapSize ] = inpVal | |
| else | |
| inputTensor[ 0 ][ i ][ yP + overlapSize ][ xP + overlapSize ][ 0 ] = inpVal | |
| if( nnpfc_auxiliary_inp_idc = = 1 ) | |
| if( !nnpfc_component_last_flag ) | |
| inputTensor[ 0 ][ i ][ 1 ][ yP + overlapSize ][ xP + overlapSize ] = StrengthControlVal | |
| else | |
| inputTensor[ 0 ][ i ][ yP + overlapSize ][ xP + overlapSize ][ 1 ] = StrengthControlVal | |
| } | |
| else if( nnpfc_inp_order_idc = = 1 ) | (82) |
| for( yP = −overlapSize; yP < inpPatchHeight + overlapSize; yP++) | |
| for( xP = −overlapSize; xP < inpPatchWidth + overlapSize; xP++ ) { | |
| inpCbVal = InpC( InpSampleVal( cTop + yP, cLeft +xP, CroppedHeight / SubHeightC, | |
| CroppedWidth / SubWidthC, CroppedCbPic[ i ] ) ) | |
| inpCrVal = InpC( InpSampleVal( cTop + yP, cLeft +xP, CroppedHeight / SubHeightC, | |
| CroppedWidth / SubWidthC, CroppedCrPic[ i ] ) ) | |
| if( !nnpfc_component_last_flag ) { | |
| inputTensor[ 0 ][ i ][ 0 ][ yP + overlapSize ][ xP + overlapSize ] = inpCbVal | |
| inputTensor[ 0 ][ i ][ 1 ][ yP + overlapSize ][ xP + overlapSize ] = inpCrVal | |
| } else { | |
| inputTensor[ 0 ][ i ][ yP + overlapSize ][ xP + overlapSize ][ 0 ] = inpCbVal | |
| inputTensor[ 0 ][ i ][ yP + overlapSize ][ xP + overlapSize ][ 1 ] = inpCrVal | |
| } | |
| if( nnpfc_auxiliary_inp_idc = = 1 ) | |
| if( !nnpfc_component_last_flag ) | |
| inputTensor[ 0 ][ i ][ 2 ][ yP + overlapSize ][ xP + overlapSize ] = StrengthControlVal | |
| else | |
| inputTensor[ 0 ][ i ][ yP + overlapSize ][ xP + overlapSize ][ 2 ] = StrengthControlVal | |
| } | |
| else if( nnpfc_inp_order_idc = = 2 ) | |
| for( yP = −overlapSize; yP < inpPatchHeight + overlapSize; yP++) | |
| for( xP = −overlapSize; xP < inpPatchWidth + overlapSize; xP++ ) { | |
| yY = cTop + yP | |
| xY = cLeft + xP | |
| yC = yY / SubHeightC | |
| xC = xY / SubWidthC | |
| inpYVal = InpY( InpSampleVal( yY, xY, CroppedHeight, | |
| CroppedWidth, CroppedYPic[ i ] ) ) | |
| inpCbVal = InpC( InpSampleVal( yC, xC, CroppedHeight / SubHeightC, | |
| CroppedWidth / SubWidthC, CroppedCbPic[ i ] ) ) | |
| inpCrVal = InpC( InpSampleVal( yC, xC, CroppedHeight / SubHeightC, | |
| CroppedWidth / SubWidthC, CroppedCrPic[ i ] ) ) | |
| if( !nnpfc_component_last_flag ) { | |
| inputTensor[ 0 ][ i ][ 0 ][ yP + overlapSize ][ xP + overlapSize ] = inpYVal | |
| inputTensor[ 0 ][ i ][ 1 ][ yP + overlapSize ][ xP + overlapSize ] = inpCbVal | |
| inputTensor[ 0 ][ i ][ 2 ][ yP + overlapSize ][ xP + overlapSize ] = inpCrVal | |
| } else { | |
| inputTensor[ 0 ][ i ][ yP + overlapSize ][ xP + overlapSize ][ 0 ] = inpYVal | |
| inputTensor[ 0 ][ i ][ yP + overlapSize ][ xP + overlapSize ][ 1 ] = inpCbVal | |
| inputTensor[ 0 ][ i ][ yP + overlapSize ][ xP + overlapSize ][ 2 ] = inpCrVal | |
| } | |
| if( nnpfc_auxiliary_inp_idc = = 1 ) | |
| if( !nnpfc_component_last_flag ) | |
| inputTensor[ 0 ][ i ][ 3 ][ yP + overlapSize ][ xP + overlapSize ] = StrengthControlVal | |
| else | |
| inputTensor[ 0 ][ i ][ yP + overlapSize ][ xP + overlapSize ][ 3 ] = StrengthControlVal | |
| } | |
| else if( nnpfc_inp_order_idc = = 3 ) | |
| for( yP = −overlapSize; yP < inpPatchHeight + overlapSize; yP++) | |
| for( xP = −overlapSize; xP < inpPatchWidth + overlapSize; xP++ ) { | |
| yTL = cTop + yP * 2 | |
| xTL = cLeft + xP * 2 | |
| yBR = yTL + 1 | |
| xBR = xTL + 1 | |
| yC = cTop / 2 + yP | |
| xC = cLeft / 2 + xP | |
| inpTLVal = InpY( InpSampleVal( yTL, xTL, CroppedHeight, | |
| CroppedWidth, CroppedYPic[ i ] ) ) | |
| inpTRVal = InpY( InpSampleVal( yTL, xBR, CroppedHeight, | |
| CroppedWidth, CroppedYPic[ i ] ) ) | |
| inpBLVal = InpY( InpSampleVal( yBR, xTL, CroppedHeight, | |
| CroppedWidth, CroppedYPic[ i ] ) ) | |
| inpBRVal = InpY( InpSampleVal( yBR, xBR, CroppedHeight, | |
| CroppedWidth, CroppedYPic[ i ] ) ) | |
| inpCbVal = InpC( InpSampleVal( yC, xC, CroppedHeight / 2, | |
| CroppedWidth / 2, CroppedCbPic[ i ] ) ) | |
| inpCrVal = InpC( InpSampleVal( yC, xC, CroppedHeight / 2, | |
| CroppedWidth / 2, CroppedCrPic[ i ] ) ) | |
| if( !nnpfc_component_last_flag ) { | |
| inputTensor[ 0 ][ i ][ 0 ][ yP + overlapSize ][ xP + overlapSize ] = inpTLVal | |
| inputTensor[ 0 ][ i ][ 1 ][ yP + overlapSize ][ xP + overlapSize ] = inpTRVal | |
| inputTensor[ 0 ][ i ][ 2 ][ yP + overlapSize ][ xP + overlapSize ] = inpBLVal | |
| inputTensor[ 0 ][ i ][ 3 ][ yP + overlapSize ][ xP + overlapSize ] = inpBRVal | |
| inputTensor[ 0 ][ i ][ 4 ][ yP + overlapSize ][ xP + overlapSize ] = inpCbVal | |
| inputTensor[ 0 ][ i ][ 5 ][ yP + overlapSize ][ xP + overlapSize ] = inpCrVal | |
| } else { | |
| inputTensor[ 0 ][ i ][ yP + overlapSize ][ xP + overlapSize ][ 0 ] = inpTLVal | |
| inputTensor[ 0 ][ i ][ yP + overlapSize ][ xP + overlapSize ][ 1 ] = inpTRVal | |
| inputTensor[ 0 ][ i ][ yP + overlapSize ][ xP + overlapSize ][ 2 ] = inpBLVal | |
| inputTensor[ 0 ][ i ][ yP + overlapSize ][ xP + overlapSize ][ 3 ] = inpBRVal | |
| inputTensor[ 0 ][ i ][ yP + overlapSize ][ xP + overlapSize ][ 4 ] = inpCbVal | |
| inputTensor[ 0 ][ i ][ yP + overlapSize ][ xP + overlapSize ][ 5 ] = inpCrVal | |
| } | |
| if( nnpfc_auxiliary_inp_idc = = 1 ) | |
| if( !nnpfc_component_last_flag ) | |
| inputTensor[ 0 ][ i ][ 6 ][ yP + overlapSize ][ xP + overlapSize ] = StrengthControlVal | |
| else | |
| inputTensor[ 0 ][ i ][ yP + overlapSize ][ xP + overlapSize ][ 6 ] = StrengthControlVal | |
| } | |
| } | |

nnpfc_separate_colour_description_present_flag equal to 1 indicates that a distinct combination of color primaries, transfer characteristics, and matrix coefficients for the picture resulting from the post-processing filter is specified in the SEI message syntax structure. nnfpc_separate_colour_description_present_flag equal to 0 indicates that the combination of color primaries, transfer characteristics, and matrix coefficients for the picture resulting from the post-processing filter is the same as indicated in VUI parameters for the CLVS.

nnpfc_colour_primaries has the same semantics as specified in subclause 7.3 for the vui_colour_primaries syntax element, except as follows:
nnpfc_colour_primaries specifies the color primaries of the picture resulting from applying the neural-network post-filter specified in the SEI message, rather than the color primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the neural-network post-filter specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs has the same semantics as specified in subclause 7.3 for the vui_matrix_coeffs syntax element, except as follows:
nnpfc_matrix_coeffs specifies the matrix coefficients of the picture resulting from applying the neural-network post-filter specified in the SEI message, rather than the matrix coefficients used for the CLVS.
When nnpfc_matrix_coeffs is not present in the NNPFC SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_out_format_idc equal to 0 indicates that the sample values output by the post-processing filter are real numbers where the value range of 0 to 1, inclusive, maps linearly to the unsigned integer value range of 0 to (1<<bitDepth)-1, inclusive, for any desired bit depth bitDepth for subsequent post-processing or displaying.

nnpfc_out_format_flag equal to 1 indicates that the sample values output by the post-processing filter are unsigned integer numbers in the range of 0 to (1<<(nnpfc_out_tensor_bitdepth_minus8+8))-1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc.

nnpfc_out_tensor_bitdepth_minus8 plus 8 specifies the bit depth of sample values in the output integer tensor. The value of nnpfc_out_tensor_bitdepth_minus8 shall be in the range of 0 to 24, inclusive.

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 or 4, nnpfc_out_order_idc shall not be equal to 3.

Table 22 contains an informative description of nnpfc_out_order_idc values.

TABLE 22
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is 3. |
| 3 | Four luma matrices and two chroma matrices are present in the output tensor, thus the number of |
| | channels is 6. This nnpfc_out_order_idc can only be used when the chroma format is 4:2:0. |
| 4 . . . 255 | Reserved |

The process StoreOutputTensors( ), for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

| | |
|---|---|
| for( i = 0; i < numInputPics; i++ ) { | |
| if( nnpfc_out_order_idc = = 0 ) | |
| for( yP = 0; yP < outPatchHeight; yP++) | |
| for( xP = 0; xP < outPatchWidth; xP++ ) { | |
| yY = cTop * outPatchHeight / inpPatchHeight + yP | |
| xY = cLeft * outPatchWidth / inpPatchWidth + xP | |
| if ( yY < nnpfc_pic_height_in_luma_samples && xY < | |
| nnpfc_pic_width_in_luma_samples ) | |
| if( !nnpfc_component_last_flag ) | |
| FilteredYPic[ i ][ xY ][yY ] = outputTensor[ 0 ][ i ][ 0 ][ yP ][ xP ] | |
| else | |
| FilteredYPic[ i ][ xY ][ yY ] = outputTensor[ 0 ][ i ][ yP ][ xP ][ 0 ] | |
| } | |
| else if( nnpfc_out_order_idc = = 1 ) | (83) |
| for( yP = 0; yP < outPatchCHeight; yP++) | |
| for( xP = 0; xP < outPatchCWidth; xP++ ) { | |
| xSrc = cLeft * horCScaling + xP | |
| ySrc = cTop * verCScaling + yP | |
| if ( ySrc < nnpfc_pic_height_in_luma_samples / outSubHeightC && | |
| xSrc < nnpfc_pic_width_in_luma_samples / outSubWidthC ) | |
| if( !nnpfc_component_last_flag ) { | |
| FilteredCbPic[ i ][ xSrc ][ ySrc ] = outputTensor[ 0 ][ i ][ 0 ][ yP ][ xP ] | |
| FilteredCrPic[ i ][ xSrc ][ ySrc ] = outputTensor[ 0 ][ i ][ 1 ][ yP ][ xP ] | |
| } else { | |
| FilteredCbPic[ i ][ xSrc ][ ySrc ] = outputTensor[ 0 ][ i ][ yP ][ xP ][ 0 ] | |
| FilteredCrPic[ i ][ xSrc ][ ySrc ] = outputTensor[ 0 ][ i ][ yP ][ xP ][ 1 ] | |
| } | |
| } | |
| else if( nnpfc_out_order_idc = = 2 ) | |
| for( yP = 0; yP < outPatchHeight; yP++) | |
| for( xP = 0; xP < outPatchWidth; xP++ ) { | |
| yY = cTop * outPatchHeight / inpPatchHeight + yP | |
| xY = cLeft * outPatchWidth / inpPatchWidth + xP | |
| yC = yY / outSubHeightC | |
| xC = xY / outSubWidthC | |
| yPc = ( yP / outSubHeightC ) * outSubHeightC | |
| xPc = ( xP / outSubWidthC ) * outSubWidthC | |
| if ( yY < nnpfc_pic_height_in_luma_samples && xY < | |
| nnpfc_pic_width_in_luma_samples) | |
| if( !nnpfc_component_last_flag ) { | |
| FilteredYPic[ i ][ xY ][ yY ] = outputTensor[ 0 ][ i ][ 0 ][ yP ][ xP ] | |
| FilteredCbPic[ i ][ xC ][ yC ] = outputTensor[ 0 ][ i ][ 1 ][ yPc ][ xPc ] | |
| FilteredCrPic[ i ][ xC ][ yC ] = outputTensor[ 0 ][ i ][ 2 ][ yPc ][ xPc ] | |
| } else { | |
| FilteredYPic[ i ][ xY ][ yY ] = outputTensor[ 0 ][ i ][ yP ][ xP ][ 0 ] | |
| FilteredCbPic[ i ][ xC ][ yC ] = outputTensor[ 0 ][ i ][ yPc ][ xPc ][ 1 ] | |
| FilteredCrPic[ i ][ xC ][ yC ] = outputTensor[ 0 ][ i ][ yPc ][ xPc ][ 2 ] | |
| } | |
| } | |
| else if( nnpfc_out_order_idc = = 3 ) | |
| for( yP = 0; yP < outPatchHeight; yP++ ) | |
| for( xP = 0; xP < outPatchWidth; xP++ ) { | |
| ySrc = cTop / 2 * outPatchHeight / inpPatchHeight + yP | |
| xSrc = cLeft / 2 * outPatchWidth / inpPatchWidth + xP | |
| if ( ySrc < nnpfc_pic_height_in_luma_samples / 2 && | |
| xSrc < nnpfc_pic_width_in_luma_samples / 2 ) | |
| if( !nnpfc_component_last_flag ) { | |
| FilteredYPic[ i ][ xSrc * 2 ][ ySrc * 2 ] = outputTensor[ 0 ][ i ][ 0 ][ yP ][ xP ] | |
| FilteredYPic[ i ][ xSrc * 2 + 1 ][ ySrc * 2 ] = outputTensor[ 0 ][ i ][ 1 ][ yP ][ xP ] | |
| FilteredYPic[ i ][ xSrc * 2 ][ ySrc * 2 + 1 ] = outputTensor[ 0 ][ i ][ 2 ][ yP ][ xP ] | |
| FilteredYPic[ i ][ xSrc * 2 + 1][ ySrc * 2 + 1 ] = outputTensor[ 0 ][ i ][ 3 ][ yP ][ xP ] | |
| FilteredCbPic[ i ][ xSrc ][ ySrc ] = outputTensor[ 0 ][ i ][ 4 ][ yP ][ xP ] | |
| FilteredCrPic[ i ][ xSrc ][ ySrc ] = outputTensor[ 0 ][ i ][ 5 ][ yP ][ xP ] | |
| } else { | |
| FilteredYPic[ i ][ xSrc * 2 ][ ySrc * 2 ] = outputTensor[ 0 ][ i ][ yP ][ xP ][ 0 ] | |
| FilteredYPic[ i ][ xSrc * 2 + 1 ][ ySrc * 2 ] = outputTensor[ 0 ][ i ][ yP ][ xP ][ 1 ] | |
| FilteredYPic[ i ][ xSrc * 2 ][ ySrc * 2 + 1 ] = outputTensor[ 0 ][ i ][ yP ][ xP ][ 2 ] | |
| FilteredYPic[ i ][ xSrc * 2 + 1][ ySrc * 2 + 1 ] = outputTensor[ 0 ][ i ][ yP ][ xP ][ 3 ] | |
| FilteredCbPic[ i ][ xSrc ][ ySrc ] = outputTensor[ 0 ][ i ][ yP ][ xP ][ 4 ] | |
| FilteredCrPic[ i ][ xSrc ][ ySrc ] = outputTensor[ 0 ][ i ][ yP ][ xP ][ 5 ] | |
| } | |
| } | |
| } | |

nnpfc_constant_patch_size_flag equal to 1 indicates that the post-processing filter accepts exactly the patch size indicated by nnpfc_patch_width_minus1 and nnpfc_patch_height_minus1 as input. nnpfc_constant_patch_size_flag equal to 0 indicates that the post-processing filter accepts any patch size that is a positive integer multiple of the patch size indicated by nnpfc_patch_width_minus1 and nnpfc_patch_height_minus1 as input.

nnpfc_patch_width_minus1+1, when nnpfc_constant_patch_size_flag equal to 1, indicates the horizontal sample counts of the patch size required for the input to the post-processing filter. The value of nnpfc_patch_width_minus1 shall be in the range of 0 to Min(32766, CroppedWidth-1), inclusive.

nnpfc_patch_height_minus1+1, when nnpfc_constant_patch_size_flag equal to 1, indicates the vertical sample counts of the patch size required for the input to the post-processing filter. The value of nnpfc_patch height_minus1 shall be in the range of 0 to Min(32766, CroppedHeight-1), inclusive.

Let the variables inpPatchWidth and inpPatchHeight be the patch size width and the patch size height, respectively.

If nnpfc_constant_patch_size_flag is equal to 0, the following applies:
The values of inpPatchWidth and inpPatchHeight are either provided by external means not specified in this document or set by the post-processor itself.
The value of inpPatchWidth shall be a positive integer multiple of nnpfc_patch_width_minus1+1 and shall be less than or equal to CroppedWidth. The value of inpPatchHeight shall be a positive integer multiple of nnpfc_patch_height_minus1+1 and shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1.

nnpfc_overlap indicates the overlapping horizontal and vertical sample counts of adjacent input tensors of the post-processing filter. The value of nnpfc_overlap shall be in the range of 0 to 16383, inclusive.

The variables outPatchWidth, outPatchHeight, horCScaling, verCScaling, outPatchCWidth, outPatchCHeight, and overlapSize are derived as follows:

$$outPatchWidth = ( nnpfc\_pic \_width \_in \_luma \_samples * inpPatchWidth ) / CroppedWidth \qquad ( 84 )$$

$$outPatchHeight = ( nnpfc\_pic \_height \_in \_luma \_samples * inpPatchHeight ) / CroppedHeight \qquad ( 85 )$$

$$horCScaling = SubWidthC / outSubWidthC \qquad ( 86 )$$

$$verCScaling = SubHeightC / outSubHeightC \qquad ( 87 )$$

$$outPatchCWidth = outPatchWidth * horCScaling \qquad ( 88 )$$

$$outPatchCHeight = outPatchHeight * verCScaling \qquad ( 89 )$$

$$overlapSize = nnpfc\_overlap \qquad ( 90 )$$

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type indicates the process of padding when referencing sample locations outside the boundaries of the cropped decoded output picture as described in Table 23. The value of nnpfc_padding_type shall be in the range of 0 to 15, inclusive.

TABLE 23
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4.

nnpfc_cr_padding_val indicates the Cr value to be used for padding when nnpfc_padding_type is equal to 4.

The function InpSampleVal(y, x, picHeight, picWidth, croppedPic) with inputs being a vertical sample location y, a horizontal sample location x, a picture height picHeight, a picture width picWidth, and sample array croppedPic returns the value of sampleVal derived as follows:

NOTE 6—For the inputs to the function InpSampleVal( ), the vertical location is listed before the horizontal location for compatibility with input tensor conventions of some inference engines.

| | |
|---|---|
| if( nnpfc_padding_type = = 0 ) | |
| if( y < 0 \| \| x < 0 \| \| y >= picHeight \| \| x >= picWidth ) | |
| sampleVal = 0 | |
| else | |
| sampleVal = croppedPic[ x ][ y ] | (91) |
| else if( nnpfc_padding_type = = 1 ) | |
| sampleVal = croppedPic[ Clip3( 0, picWidth − 1, x) ][ Clip3( 0, picHeight − 1, y ) ] | |
| else if( nnpfc_padding_type = = 2 ) | |
| sampleVal = croppedPic[ Reflect( picWidth − 1, x ) ][ Reflect( picHeight − 1, y ) ] | |
| else if( nnpfc_padding_type = = 3 ) | |
| if( y >= 0 && y < picHeight ) | |
| sampleVal = croppedPic[ Wrap( picWidth − 1, x ) ][ y ] | |
| else if( nnpfc_padding_type = = 4 ) | |
| if( y < 0 \| \| x <0 \| \| y >= picHeight \| \| x >= picWidth ) | |
| sampleVal[ 0 ] = nnpfc_luma_padding_val | |
| sampleVal[ 1 ] = nnpfc_cb_padding_val | |
| sampleVal[ 2 ] = nnpfc_cr_padding_val | |
| else | |
| sampleVal = croppedPic[ x ][ y ] | |

The following example process may be used to filter the cropped decoded output picture patch-wise with the post-processing filter PostProcessingFilter( ) to generate the filtered picture, which contains Y, Cb, and Cr sample arrays FilteredYPic, FilteredCbPic, and FilteredCrPic, respectively, as indicated by nnpfc_out_order_idc.

| | |
|---|---|
| if( nnpfc_inp_order_idc = = 0 ) | |
| for( cTop = 0; cTop < CroppedHeight; cTop += inpPatchHeight ) | |
| for( cLeft = 0; cLeft < CroppedWidth; cLeft += inpPatchWidth ) { | |
| DeriveInputTensors( ) | |
| outputTensor = PostProcessingFilter( inputTensor ) | |
| StoreOutputTensors( ) | |
| } | |
| else if( nnpfc_inp_order_idc = = 1 ) | |
| for( cTop = 0; cTop < CroppedHeight / SubHeightC; cTop += inpPatchHeight ) | |
| for( cLeft = 0; cLeft < CroppedWidth / SubWidthC; cLeft += inpPatchWidth ) { | |
| DeriveInputTensors( ) | |
| outputTensor = PostProcessingFilter( inputTensor ) | |
| StoreOutputTensors( ) | |
| } | |
| else if( nnpfc_inp_order_idc = = 2 ) | |
| for( cTop = 0; cTop < CroppedHeight; cTop += inpPatchHeight) | (92) |
| for( cLeft = 0; cLeft < CroppedWidth; cLeft += inpPatchWidth) { | |
| DeriveInputTensors( ) | |
| outputTensor = PostProcessingFilter( inputTensor ) | |
| StoreOutputTensors( ) | |
| } | |
| else if( nnpfc_inp_order_idc = = 3 ) | |
| for( cTop = 0; cTop < CroppedHeight; cTop += inpPatchHeight * 2 ) | |
| for( cLeft = 0; cLeft < CroppedWidth; cLeft += inpPatchWidth * 2 ) { | |
| DeriveInputTensors( ) | |
| outputTensor = PostProcessingFilter( inputTensor ) | |
| StoreOutputTensors( ) | |
| } | |

nnpfc_complexity_info_present_flag equal to 1 specifies that one or more syntax elements that indicate the complexity of the post-processing filter associated with the nnpfc_id are present. nnpfc_complexity_info_present_flag equal to 0 specifies that no syntax elements that indicates the complexity of the post-processing filter associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T|ISO/IEC and shall not be present in bitstreams conforming to this edition of this document. Decoders conforming to this edition of this document shall ignore NNPFC SEI messages with nnpfc_parameter_type_idc equal to 3.

nnpfc_log 2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log 2_parameter_bit_length_minus3 is not present the neural network does not use parameters of bit length greater than 1.

nnpfc_num_parameters_idc indicates the maximum number of neural network parameters for the post processing filter in units of a power of 2048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T|ISO/IEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows:

$$maxNumParameters = ( 2048 ≪ nnpfc\_num \_parameters \_idc ) - 1 \qquad ( 93 )$$

It is a requirement of bitstream conformance that the number of neural network parameters of the post-processing filter shall be less than or equal to maxNumParameters.

nnpfc_num_kmac_operations_idc greater than 0 indicates that the maximum number of multiply-accumulate operations per sample of the post-processing filter is less than or equal to nnpfc_num_kmac_operations_idc*1000. nnpfc_num_kmac_operations_idc equal to 0 indicates that the maximum number of multiply-accumulate operations of the network is unknown. The value of nnpfc_num_kmac_operations_idc shall be in the range of 0 to 2³²-1, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8000, rounded up. nnpfc_total_kilobyte_size equal to 0 indicates that the total size required to store the parameters for the neural network is unknown. The value of nnpfc_total_kilobyte_size shall be in the range of 0 to 2³²-1, inclusive.

nnpfc_reserved_zero_bit_b shall be equal to 0 in bitstreams conforming to this edition of this document. Decoders shall ignore NNPFC SEI messages in which nnpfc_reserved_zero_bit_b is not equal to 0.

nnpfc_payload_byte[i] contains the i-th byte of a bitstream conforming to ISO/IEC 15938-17. The byte sequence nnpfc_payload_byte[i] for all present values of i shall be a complete bitstream that conforms to ISO/IEC 15938-17.

### 8.29 Neural-Network Post-Filter Activation SEI Message

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| } | |

### 8.29.2 Neural-Network Post-Filter Activation SEI Message Semantics

The neural-network post-filter activation (NNPFA) SEI message activates or de-activates the possible use of the target neural-network post-processing filter, identified by nnpfa_target_id, for post-processing filtering of a set of pictures.

NOTE 1—There can be several NNPFA SEI messages present for the same picture, for example, when the post-processing filters are meant for different purposes or filter different color components.

nnpfa_target_id indicates the target neural-network post-processing filter, which is specified by one or more neural-network post-processing filter characteristics SEI messages that pertain to the current picture and have nnpfc_id equal to nnfpa_target_id.

The value of nnpfa_target_id shall be in the range of 0 to 2³²-2, inclusive. Values of nnpfa_target_id from 256 to 511, inclusive, and from 2³¹ to 2³²-2, inclusive, are reserved for future use by ITU-T|ISO/IEC. Decoders conforming to this edition of this document encountering an NNPFA SEI message with nnpfa_target_id in the range of 256 to 511, inclusive, or in the range of 2³¹ to 2³²-2, inclusive, shall ignore the SEI message.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target neural-network post-processing filter established by any previous NNPFA SEI message with the same nnpfa_target_id as the current SEI message is cancelled, i.e., the target neural-network post-processing filter is no longer used unless it is activated by another NNPFA SEI message with the same nnpfa_target_id as the current SEI message and nnpfa_cancel_flag equal to 0. nnpfa_cancel_flag equal to 0 indicates that the nnpfa_persistence_flag follows.

nnpfa_persistence_flag specifies the persistence of the target neural-network post-processing filter for the current layer.

nnpfa_persistence_flag equal to 0 specifies that the target neural-network post-processing filter may be used for post-processing filtering for the current picture only.

nnpfa_persistence_flag equal to 1 specifies that the target neural-network post-processing filter may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.

NOTE 2—The target neural-network post-processing filter is not applied for this subsequent picture in the current layer associated with a NNPFA SEI message with the same nnpfa_target_id as the current SEI message and nnpfa_cancel_flag equal to 1.

### 4. Technical Problems Addressed by Disclosed Embodiments

An example design for the neural-network post-filter characteristics (NNPFC) SEI message has the following problems:

First, neural-network post-filter (NNPF) purposes with chroma upsampling only, resolution upsampling only, both chroma upsampling and resolution upsampling, and picture rate upsampling only are specified. However, picture rate upsampling in combination with other types of upsampling can also be used in video applications. Therefore, there is a need to be able to signal NNPF purposes with picture rate upsampling in combination with other types of upsampling.

Second, when picture rate upsampling is in use, a value for indicating the number of interpolated pictures between each pair of consecutive input pictures is signalled. However, in most common cases, the number of interpolated pictures between every pair of consecutive input pictures is the same. Therefore, it is desirable to make the signalling more efficient for common cases by signalling only one value for indicating the number of interpolated pictures between every pair of consecutive input pictures.

Third, when multiple types of upsampling (such as chroma upsampling, resolution upsampling, and picture rate upsampling) are performed, the order might need to be clearly specified or signalled.

Fourth, when neural-network post-filter (NNPF) purpose is specified as visual quality improvement only, chroma upsampling only, resolution upsampling only, or chroma upsampling and resolution upsampling, only one input picture is used. However, it might be beneficial to input multiple pictures for these purposes.

Fifth, when picture rate upsampling in combination with other types of upsampling (such as chroma upsampling and resolution upsampling) or picture rate upsampling in combination with visual quality improvement are performed by an NNPF, the input pictures themselves are also filtered and the filtered versions of the input pictures are output. For example, if the input pictures are pictures 0 and 2, and picture 1 is interpolated and output, in the combination modes above, pictures 0 and 2 are also filtered and output. However, when applying the NNPF with input of pictures 2 and 4 to interpolate picture 3 in such a combination mode, picture 2 is filtered again. Therefore, there needs to be a scheme for such combination modes to be able to implement picture rate upsampling for a video bitstream while at the same time avoiding filtering certain input pictures multiple times. When a picture is filtered multiple times, it needs to define/signal a strategy to determine which filtered version will be outputted.

Sixth, there lacks a mechanism to add the support of the combination of picture rate upsampling in combination with visual quality improvement without adding a new NNPF purpose.

Seventh, when a NNPF purpose is specified as visual quality improvement only, chroma upsampling only, resolution upsampling only, or chroma upsampling and resolution upsampling, and even when multiple input pictures are used, currently only one picture is filtered and output. It would be desirable to be able to filter and output multiple pictures in such cases.

### 5. A Listing of Solutions and Embodiments

To address at least some of the above-described problems, methods as summarized below are disclosed. The aspects should be considered as examples to explain the general concepts and should not be interpreted in a narrow way. Furthermore, these examples can be applied individually or combined in any manner.
1) To address drawbacks of problem 1, one or more of the following new purposes are defined:
   a. In one example, a new purpose is defined for picture rate upsampling and chroma upsampling, without resolution upsampling.
   b. In one example, a new purpose is defined for picture rate upsampling and resolution upsampling, without chroma upsampling.
   c. In one example, a new purpose is defined for picture rate upsampling, resolution upsampling, and chroma upsampling.
   d. In one example, a new purpose is defined for picture rate upsampling and visual quality improvement.
2) To address drawbacks of problem 2, an indication is signalled to indicate whether the number of interpolated pictures between every pair of consecutive input pictures is the same.
   a. In one example, furthermore, when it is indicated that the number of interpolated pictures between every pair of consecutive input pictures is the same, an indication of the number of interpolated pictures between every pair of consecutive input pictures is signalled.
      i. In one example, furthermore, the number of interpolated pictures between every pair of consecutive input pictures minus one is signalled.
         1. In one example, furthermore, the value of number minus one is restricted to be in the range of 0 to N, inclusive, where N is an integer.
         a. In one example, furthermore, N is specified to be 1, 3, 7, 15, 31, or 63.
3) To address drawbacks of problem 2, an indication is signalled to indicate whether a fixed output frame rate is the same which means the number of interpolated pictures between every pair of consecutive input pictures is the same.
   a. In one example, furthermore, when it is indicated that the number of interpolated pictures between every pair of consecutive input pictures is the same, an indication of the output frame rate or the ratio between the output frame rate and the input framerate is further signalled.
      i. In one example, furthermore, the output frame rate minus the input frame rate is signalled.
         1. Alternatively, furthermore, the output frame rate minus the input frame rate minus 1 is signalled.
         2. In one example, furthermore, the output frame rate minus the input frame rate may be signalled by a ue(v) or u(N) coded syntax element.
      ii. In one example, furthermore, the ratio between the output frame rate and the input frame rate is signalled.
         1. Alternatively, furthermore, the ratio between the output frame rate and the input frame rate minus 1 is signalled.
         2. In one example, furthermore, the ratio between the output frame rate and the input frame rate minus K (e.g., K=0 or 1) may be signalled with multiple syntax elements.
         a. Alternatively, furthermore, the ratio between the output frame rate and the input frame rate may be signalled using two ue(v)-coded syntax elements, e.g., with frr_a_minusK and frr_b_minusL and the ratio is set equal to (frr_a_minusK+K)÷frr_a_minusK+K−(frr_b_minusL+L)), where K and L are integer values, e.g., both are 1.
4) To address drawbacks of problem 3, when multiple types of upsampling (such as chroma upsampling, resolution upsampling, and picture rate upsampling) are performed, the order of the multiple types of upsampling may be determined, and specified or signalled.
   a. In one example, the order may be predefined or fixed.
      i. In one example, it is specified that, when both picture rate upsampling and resolution upsampling are performed, picture rate upsampling should be performed after/before resolution upsampling.
      ii. In one example, it is specified that, when both chroma upsampling and resolution upsampling are performed, chroma upsampling should be performed before/after resolution upsampling.
      iii. In one example, it is specified that, when both chroma upsampling and picture rate upsampling are performed, picture rate upsampling should be performed after/before chroma upsampling.
      iv. In one example, these above inventions could be combined in any manner.
   b. In one example, the order may be signaled. E.g., at least one syntax element may be signaled to indicate the order of different upsampling methods.
   c. In one example, the order may be adaptive.
      i. In one example, the order may be dependent on the coding modes/statistics of the video unit (e.g., prediction modes, qp, temporal layer, slice type, etc.).
   d. In one example, the order may be dependent on the priority of NNPF purpose when multiple types of NNPF are performed.
      i. In one example, the priority may be signalled.
         1. In one example, the priority may be signalled by a ue(v) or u(N) coded syntax element.
         2. In one example, the value of priority is restricted to be in the range of 0 to N, inclusive, where N is an integer.
         3. In one example, the NNPF with larger priority is performed before the NNPF with smaller priority.
5) To address drawbacks of problem 4, the number of input pictures may be specified for any of the neural-network post-filter (NNPF) purposes.
   a. In one example, the number of input pictures may be specified for the purpose of visual quality improvement.
   b. In one example, the number of input pictures may be specified for the purpose of chroma upsampling.
   c. In one example, the number of input pictures may be specified for the purpose of resolution upsampling.
   d. In one example, the number of input pictures may be specified for the purpose of chroma upsampling and resolution upsampling.
   e. In one example, the number of input pictures minus 1, e.g., denoted as nnpfc_num_input_pics_minus1 is signalled, the number of input pictures, e.g., denoted as numInputPics, is calculated as: numInputPics=nnpfc_num_input_pics_minus1+1.
      i. In one example, it is constrained that, when picture rate upsampling is in use, the value of nnpfc_num_input_pics_minus1 shall be greater than 0.
   f. In one example, the number of input pictures may be different when processing different frames. The number of input pictures may be signalled for each frame.
   g. In one example, which pictures are used as input of NNPF purposes may be applied according to the certain or adaptive rule.
      i. In one example, it may be dependent on the coding modes/statistics of the video unit (e.g., prediction modes, qp, temporal layer, slice type, etc.).
      ii. In one example, it may be predefined or fixed.
         1. In one example, all the reconstructed pictures in decoding order could be used as input.
         2. In one example, all the reconstructed pictures in display order could be used as input.
      iii. In one example, it may be signalled.
         1. In one example, a list of indexes of pictures is signalled for each frame, which indicates the pictures will used as input.
6) To address drawbacks of problems 5, 6, and 7, when multiple input pictures are used for an NNPF, it is allowed for the NNPF to generate output pictures corresponding to some of the input pictures but not to generate output pictures corresponding to other input pictures, and furthermore, one or more of the following aspects apply:
   a. In one example, when the number of input pictures is greater than 1, an indication is included in the NNPFC SEI message to indicate for which of the input pictures the NNPF generates corresponding output pictures, in addition to possibly one or more pictures interpolated and output by the NNPF.
   b. In one example, when the purpose of the NNPF indicates that picture rate upsampling is performed by the NNPF, with or without other types upsampling performed also by the NNPF, an indication is included in the NNPFC SEI message to indicate for which of the input pictures the NNPF generates corresponding output pictures, in addition to one or more pictures interpolated and output by the NNPF.
   c. In one example, one particular value of the indication indicates that for none of the input pictures the NNPF generates corresponding output pictures. This is equivalent to picture rate upsampling without visual quality improvement to any of the input pictures.
   d. In one example, one particular value of the indication indicates that for all of the input pictures the NNPF generates corresponding output pictures. This is equivalent to picture rate upsampling with visual quality improvement to all the input pictures.
   e. In one example, one particular value of the indication indicates that for all of the input pictures but the first one in output order the NNPF generates corresponding output pictures. This can be used to avoid filtering a particular existing picture multiple times.
   f. In one example, one particular value of the indication indicates that for all of the input pictures but the last one in output order the NNPF generates corresponding output pictures.
   g. In one example, whether for each of the input pictures the NNPF generates a corresponding output picture is separately indicated by the indication, e.g., by a flag in the indication for each of the input pictures, one value of the flag indicates that for the corresponding input picture the NNPF generates a corresponding output picture, and another value of the flag indicates that for the corresponding input picture the NNPF does not generate a corresponding output picture. This can be used to achieve what can be achieved by items 6.c, 6.d, 6.e, and 6.f, and more, e.g., when an NNPF does spatial resolution upsampling only, it can take multiple input pictures, say input pictures 0 to 5, and generates two output pictures corresponding to the two input pictures in the middle of the list of input pictures, i.e., input pictures 2 and 4.
   h. In one example, furthermore, when the purpose indicates that no picture upsampling is in use and there are multiple input pictures, it is required that at the value of the indication shall be such that for at least one input picture a corresponding output picture is generated by the NNPF.
   i. In one example, the indication is signalled in the NNPFA SEI message.

### 6. Embodiments

Below are some example embodiments for the aspects summarized in section 5. Most relevant parts that have been added or modified are shown in double braces (i.e., {{a}} indicates that ‘a’ is added), and some of the deleted parts are shown in triple brackets (i.e., [[[a]]] indicates that ‘a’ is deleted). There may be some other changes that are editorial in nature and thus not highlighted.

### 6.1 First Embodiment

This embodiment is for the items 1 and 2 and all their subitems summarized above in Section 5.

### 8.28.1 Neural-Network Post-Filter Characteristics SEI Message Syntax

| | De- |
|---|---|
| | scrip- |
| | tor |
| nn_post_filter_characteristics( payloadSize ) { | |
| ... | |
| nnpfc_purpose | ue(v) |
| /* input and output formatting */ | |
| if( nnpfc_purpose = = 2 \| \| nnpfc_purpose = = 4 {{\| \| | |
| nnpfc_purpose = = 6 \| \| nnpfc_purpose = = 8 }} ) { | |
| nnpfc_out_sub_c_flag | u(1) |
| [[[else ]]]if( nnpfc_purpose = = 3 \| \| nnpfc_purpose = = | |
| 4 {{\| \| nnpfc_purpose = = 7 \| \| | |
| nnpfc_purpose = = 8 )}} { | |
| nnpfc_pic_width_in_luma_samples | ue(v) |
| nnpfc_pic_height_in_luma_samples | ue(v) |
| } | |
| [[[else ]]]if( nnpfc_purpose = = 5 {{\| \| nnpfc_purpose = = | |
| 6 \| \| nnpfc_purpose = = 7 \| \| | |
| nnpfc_purpose = = 8 \| \| nnpfc_purpose = = 9}} ) { | |
| nnpfc_num_input_pics_minus2 | ue(v) |
| {{nnpfc_same_interpolted_pic_num_flag | u(1) |
| if( nnpfc_same_interpolted_pic_num_flag) | |
| nnpfc_num_interpolated_pics_minus1 | ue(v) |
| else}] | |
| for( i = 0; i <= nnpfc_num_input_pics_minus2; i++ ) | |
| nnpfc_interpolated_pics[ i ] | ue(v) |
| } | |
| ... | |
| } | |

### 8.28.2 Neural-Network Post-Filter Characteristics SEI Message Semantics

nnpfc_purpose indicates the purpose of the post-processing filter as specified in Table 20.

The value of nnpfc_purpose shall be in the range of 0 to {{9 }} [[[5]]], inclusive, in bitstreams conforming to this edition of this document. Values of {{110}} [[[6]]] to 1023, inclusive, for nnpfc_purpose are reserved for future use by JTU-T|ISO/IEC and shall not be present in bitstreams conforming to this edition of this document. Decoders conforming to this edition of this document shall ignore NNPFC SEI messages with nnpfc-purpose in the range of {{10}} [[[6]]] to {{1023}} [[[1203]]], inclusive. Values of nnpfc purpose greater than 1023 shall not be present in bitstreams conforming to this edition of this document and are not reserved for future use.

TABLE 20
Definition of nnpfc_purpose

| Value | Interpretation |
|---|---|
| 0 | May be used as determined by the application |
| 1 | Visual quality improvement{{, without any of chroma upsampling, resolution upsampling, and |
| | picture rate upsampling}} |
| 2 | Chroma upsampling (from the 4:2:0 chroma format to the 4:2:2 or 4:4:4 chroma format, or from the |
| | 4:2:2 chroma format to the 4:4:4 chroma format) |
| 3 | {{Resolution upsampling (increasing}} [[[Increasing]]] the width or height of the cropped decoded |
| | output picture) without {{chroma upsampling and without picture rate upsampling}} [[[changing the |
| | chroma format]]] |
| 4 | {{Resolution upsampling and chroma upsampling, without picture rate upsampling}} [[[Increasing |
| | the width or height of the cropped decoded output picture and upsampling the chroma format]]] |
| 5 | Picture rate upsampling{{, without chroma upsampling and without resolution upsampling |
| 6 | Picture rate upsampling and chroma upsampling, without resolution upsampling |
| 7 | Picture rate upsampling and resolution upsampling, without chroma upsampling |
| 8 | Picture rate upsampling, chroma upsampling, and resolution upsampling |
| 9 | Picture rate upsampling and visual quality improvement, without chroma upsampling and without |
| | resolution upsampling}} |

NOTE 3—When a reserved value of nnpfc_purpose is taken into use in the future by ITU-T|ISO/IEC, the syntax of this SEI message could be extended with syntax elements whose presence is conditioned by nnpfc-purpose being equal to that value.

When SubWidthC is equal to 1 and SubHeightC is equal to 1, nnpfc-purpose shall not be equal to 2{{, 4, 6, or 8}} [[[or 4]]].

nnpfc_out_sub_cjflag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_cflag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

nnpfc_num_input_pics_minus2 plus 2 specifies the number of decoded output pictures used as input for the post-processing filter.

{{nnpfc_same_interpolted_pic_num_flag equal to 1 indicates that the number of interpolated pictures between every pair of consecutive input pictures is the same. nnpfc_same_interpolted_pic_num_flag equal to 0 indicates that the number of interpolated pictures between every pair of consecutive input pictures may or may not be the same.

nnpfc_num_interpolated_pics_minus1 plus 1 specifies the number of interpolated pictures between every pair of consecutive input pictures when nnpfc_same_interpolted_pic_num_flag is equal to 1. The value of nnpfc_num_interpolated_pics_minus1 shall be in the range of 0 to 31, inclusive.}}

nnpfc_interpolated_pics[i] specifies the number of interpolated pictures generated by the post-processing filter between the i-th and the (i+1)-th picture used as input for the post-processing filter {{when nnpfc_same_interpolted_pic_num_flag is equal to 0.}}

The variables numInputPics, specifying the number of pictures used as input for the post-processing filter, and numOutputPics, specifying the total number of pictures resulting from the post-processing filter, are derived as follows:

| | |
|---|---|
| if( nnpfc_purpose = = 5 {{\| \| nnpfc_purpose = = 6 \| \| nnpfc_purpose = = 7 \| \| nnpfc_purpose = = 8 \| \| | |
| nnpfc_purpose = = 9}} ) { | |
| numInputPics = nnpfc_num_input_pics_minus2 + 2 | |
| {{numOutputPics = ( nnpfc_purpose = = 5 ) ? 0: numInputPics}} | |
| for( i = 0, [[[numOutputPics = 0]]]; i <= numInputPics − 2; i++ ) | (76) |
| numOutputPics += {{nnpfc_same_interpolted_pic_num_flag ? | |
| nnpfc_num_interpolated_pics_minus1 + 1}} : nnpfc_interpolated_pics[ i ] | |
| } else { | |
| numInputPics = 1 | |
| {{numOutputPics = 1}} | |
| } | |

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2, {{4, 6, or 8}} [[[or 4]]], nnpfc_out_order_idc shall not be equal to 3.

Table 22 contains an informative description of nnpfc_out_order_idc values.

TABLE 22
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is 3. |
| 3 | Four luma matrices and two chroma matrices are present in the output tensor, thus the number of |
| | channels is 6. This nnpfc_out_order_idc can only be used when the chroma format is 4:2:0. |
| 4 . . . 255 | Reserved |

The process StoreOutputTensors( ), for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < {{numOutputPics}} [[[numInputPics]]]; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY <
nnpfc_pic_width_in_luma_samples )
          if( !nnpfc_component_last_flag )
          FilteredYPic[ i ][ xY ][yY ] = outputTensor[ 0 ][ i ][ 0 ][ yP ][ xP ]
          else
          FilteredYPic[ i ][ xY ][ yY ] = outputTensor[ 0 ][ i ][ yP ][ xP ][ 0 ]
      }
  else if( nnpfc_out_order_idc = = 1 ) (83)
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
          xSrc < nnpfc_pic_width_in_luma_samples / outSubWidthC )
          if( !nnpfc_component_last_flag ) {
          FilteredCbPic[ i ][ xSrc ][ ySrc ] = outputTensor[ 0 ][ i ][ 0 ][ yP ][ xP ]
          FilteredCrPic[ i ][ xSrc ][ ySrc ] = outputTensor[ 0 ][ i ][ 1 ][ yP ][ xP ]
          } else {
          FilteredCbPic[ i ][ xSrc ][ ySrc ] = outputTensor[ 0 ][ i ][ yP ][ xP ][ 0 ]
          FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = (xP / outSubWidthC ) * outSubWidthC
        if ( yY < nnpfc_pic_height_in_luma_samples && xY <
nnpfc_pic_width_in_luma_samples)
          if( !nnpfc_component_last_flag ) {
          FilteredYPic[ i ][ xY ][ yY ] = output Tensor[ 0 ][ i ][ 0 ][ yP ][ xP ]
          FilteredCbPic[ i ][ xC ][ yC ] = outputTensor[ 0 ][ i ][ 1 ][ yPc ][ xPc ]
          FilteredCrPic[ i ][ xC ][ yC ] = outputTensor[ 0 ][ i ][ 2 ][ yPc ][ xPc ]
          } else {
          FilteredYPic[ i ][ xY ][ yY ] = outputTensor[ 0 ][ i ][ yP ][ xP ][ 0 ]
          FilteredCbPic[ i ][ xC ][ yC ] = outputTensor[ 0 ][ i ][ yPc ][ xPc ][ 1 ]
          FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
          FilteredYPic[ i ][ xSrc * 2 ][ ySrc * 2 ] = outputTensor[ 0 ][ i ][ 0 ][ yP ][ xP ]
          FilteredYPic[ i ][ xSrc * 2 + 1 ][ ySrc * 2 ] = outputTensor[ 0 ][ i ][ 1 ][ yP ][ xP ]
          FilteredYPic[ i ][ xSrc * 2 ][ ySrc * 2 + 1 ] = outputTensor[ 0 ][ i ][ 2 ][ yP ][ xP ]
          FilteredYPic[ i ][ xSrc * 2 + 1][ ySrc * 2 + 1 ] = outputTensor[ 0 ][ i ][ 3 ][ yP ][ xP ]
          FilteredCbPic[ i ][ xSrc ][ ySrc ] = outputTensor[ 0 ][ i ][ 4 ][ yP ][ xP ]
          FilteredCrPic[ i ][ xSrc ][ ySrc ] = outputTensor[ 0 ][ i ][ 5 ][ yP ][ xP ]
          } else {
          FilteredYPic[ i ][ xSrc * 2 ][ ySrc * 2 ] = outputTensor[ 0 ][ i ][ yP ][ xP ][ 0 ]
          FilteredYPic[ i ][ xSrc * 2 + 1 ][ ySrc * 2 ] = outputTensor[ 0 ][ i ][ yP ][ xP ][ 1 ]
          FilteredYPic[ i ][ xSrc * 2 ][ ySrc * 2 + 1 ] = outputTensor[ 0 ][ i ][ yP ][ xP ][ 2 ]
          FilteredYPic[ i ][ xSrc * 2 + 1][ ySrc * 2 + 1 ] = outputTensor[ 0 ][ i ][ yP ][ xP ][ 3 ]
          FilteredCbPic[ i ][ xSrc ][ ySrc ] = outputTensor[ 0 ][ i ][ yP ][ xP ][ 4 ]
          FilteredCrPic[ i ][ xSrc ][ ySrc ] = outputTensor[ 0 ][ i ][ yP ][ xP ][ 5 ]
          }
      }
}
```

### 6.2 Embodiment 2

This embodiment is for the items 1 and 2 and all their subitems, excluding item 1.d, summarized above in Section 5.

### 8.28.1 Neural-Network Post-Filter Characteristics SEI Message Syntax

| | Descriptor |
|---|---|
| nn_post_filter_characteristics( payloadSize ) { | |
| ... | |
| nnpfc_purpose | ue(v) |
| /* input and output formatting */ | |
| if( {{nnpfc_purpose & 0x1 != 0}}[[[ nnpfc_purpose = = 2 \|\| nnpfc_purpose = = | |
| 4]]] ) | |
| nnpfc_out_sub_c_flag | u(1) |
| [[[else ]]]if( {{nnpfc_purpose & 0x2 != 0}} [[[nnpfc_purpose | |
| = = 3 \|\| nnpfc_purpose = = 4]]] ) { | |
| nnpfc_pic_width_in_luma_samples | ue(v) |
| nnpfc_pic_height_in_luma_samples | ue(v) |
| } | |
| [[[else ]]]if( {{nnpfc_purpose & 0x4 != 0}} [[[nnpfc_purpose = = 5]]] ) { | |
| nnpfc_num_input_pics_minus2 | ue(v) |
| {{nnpfc_same_interpolted_pic_num_flag | u(1) |
| if( nnpfc_same_interpolted_pic_num_flag | |
| nnpfc_num_interpolated_pics_minus1 | ue(v) |
| else}} | |
| for( i= 0; i <= nnpfc_num_input_pics_minus2; i++ ) | |
| nnpfc_interpolated_pics[ i ] | ue(v) |
| } | |
| ... | |
| } | |

### 8.28.2 Neural-Network Post-Filter Characteristics SEI Message Semantics

nnpfc_purpose indicates the purpose of the post-processing filter as specified in Table 20.

The value of nnpfc_purpose shall be in the range of 0 to {{8}} [[5]], inclusive, in bitstreams conforming to this edition of this document. Values of {{9}} [6] to 1023, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of {{9}} [6] to {{1023}} [[[1203]]], inclusive. Values of nnpfc_purpose greater than 1023 shall not be present in bitstreams conforming to this edition of this document and are not reserved for future use.

TABLE 20
Definition of nnpfc_purpose

| Value | Interpretation |
|---|---|
| 0 | May be used as determined by the application |
| 1 | Visual quality improvement{{, without any of chroma upsampling, resolution upsampling, and |
| | picture rate upsampling}} |
| 2 | Chroma upsampling (from the 4:2:0 chroma format to the 4:2:2 or 4:4:4 chroma format, or from the |
| | 4:2:2 chroma format to the 4:4:4 chroma format) |
| 3 | {{Resolution upsampling (increasing}} [[[Increasing]]] the width or height of the cropped decoded |
| | output picture{{)}} without {{chroma upsampling and without picture rate upsampling}} |
| | [[[changing the chroma format]]] |
| 4 | {{Resolution upsampling and chroma upsampling, without picture rate upsampling}} [[[Increasing |
| | the width or height of the cropped decoded output picture and upsampling the chroma format]]] |
| 5 | Picture rate upsampling{{, without chroma upsampling and without resolution upsampling |
| 6 | Picture rate upsampling and chroma upsampling, without resolution upsampling |
| 7 | Picture rate upsampling and resolution upsampling, without chroma upsampling |
| 8 | Picture rate upsampling, chroma upsampling, and resolution upsampling}} |

NOTE 3—When a reserved value of nnpfc_purpose is taken into use in the future by ITU-T|ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 {{, 4, 6, or 8}} [or 4].

nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

nnpfc_num_input_pics_minus2 plus 2 specifies the number of decoded output pictures used as input for the post-processing filter.

{{nnpfc_same_interpolted_pic_num_flag equal to 1 indicates that the number of interpolated pictures between every pair of consecutive input pictures is the same. nnpfc_same_interpolted_pic_num_flag equal to 0 indicates that the number of interpolated pictures between every pair of consecutive input pictures may or may not be the same.

nnpfc_num_interpolated_pics_minus1 plus 1 specifies the number of interpolated pictures between every pair of consecutive input pictures when nnpfc_same_interpolted_pic_num_flag is equal to 1. The value of nnpfc_num_interpolated_pics_minus1 shall be in the range of 0 to 31, inclusive.}}

nnpfc_interpolated_pics[i] specifies the number of interpolated pictures generated by the post-processing filter between the i-th and the (i+1)-th picture used as input for the post-processing filter {{when nnpfc_same_interpolted_pic_num_flag is equal to 0.}}

The variables numInputPics, specifying the number of pictures used as input for the post-processing filter, and numOutputPics, specifying the total number of pictures resulting from the post-processing filter, are derived as follows:

```
if( {{nnpfc_purpose & 0x4 != 0}} [[[nnpfc_purpose = = 5]]] ) {
numInputPics = nnpfc_num_input_pics_minus2 + 2
{{numOutputPics = ( nnpfc_purpose = = 5 ) ? 0: numInputPics}}
for( i = 0, [[[numOutputPics = 0]]]; i <= numInputPics − 2; i++ ) (76)
  numOutputPics += {{nnpfc_same_interpolted_pic_num_flag ?
    nnpfc_num_interpolated_pics_minus1 + 1 :}} nnpfc_interpolated_pics[ i ]
} else {
numInputPics = 1
{{numOutputPics = 1}}
}
```

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 {{, 4, 6, or 8}} [[[or 4]]], nnpfc_out_order_idc shall not be equal to 3.

Table 22 contains an informative description of nnpfc_out_order_idc values.

TABLE 22
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is 3. |
| 3 | Four luma matrices and two chroma matrices are present in the output tensor, thus the number of |
| | channels is 6. This nnpfc_out_order_idc can only be used when the chroma format is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < {{numOutputPics}} [[[numInputPics]]]; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
  else if( nnpfc_out_order_idc = = 1 ) (83)
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = (xP / outSubWidthC ) * outSubWidthC
        if ( yY < nnpfc_pic_height_in_luma_samples && xY < nnpfc_pic_width_in_luma_samples)
          if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

### 6.3 Embodiment 3

This embodiment is for the items 1, 2, and 5 and all their subitems summarized above in Section 5.

### 8.28.1 Neural-Network Post-Filter Characteristics SEI Message Syntax

| | Descriptor |
|---|---|
| nn_post_filter_characteristics( payloadSize ) { | |
| ... | |
| nnpfc_purpose | ue(v) |
| /* input and output formatting */ | |
| {{nnpfc_num_input_pics_minus1 | ue(v)}} |
| if( nnpfc_purpose = = 2 \|\| nnpfc_purpose = = {{4 \|\| nnpfc_purpose = = 6 \|\| | |
| nnpfc_purpose = = 8}} ) | |
| nnpfc_out_sub_c_flag | u(1) |
| [[[else]]] if( nnpfc_purpose = = 3 \|\| nnpfc_purpose = = {{4 \|\| nnpfc_purpose = = | |
| 7 \|\| | |
| nnpfc_purpose = = 8}} ) { | |
| nnpfc_pic_width_in_luma_samples | ue(v) |
| nnpfc_pic_height_in_luma_samples | ue(v) |
| } | |
| [[[else]]] if( nnpfc_purpose = = 5 {{\|\| nnpfc_purpose = = 6 \|\| nnpfc_purpose = = | |
| 7 \|\| | |
| nnpfc_purpose = = 8 \|\| | |
| nnpfc_purpose = = 9}} ) { | |
| [[[nnpfc_num_input_pics_minus2 | ue(v)]]] |
| {{nnpfc_same_interpolted_pic_num_flag | u(1) |
| if( nnpfc_same_interpolted_pic_num_flag) | |
| nnpfc_num_interpolated_pics_minus1 | ue(v) |
| Else}} | |
| for( i = 0; i <= [[[nnpfc_num_input_pics_minus2]]] | |
| {{nnpfc_num_input_pics_minus1 − 1}}; i++ ) | |
| nnpfc_interpolated_pics[ i ] | ue(v) |
| } | |
| ... | |
| } | |

### 8.28.2 Neural-Network Post-Filter Characteristics SEI Message Semantics

nnpfc_purpose indicates the purpose of the post-processing filter as specified in Table 20.

The value of nnpfc_purpose shall be in the range of 0 to {{9}} [[5]], inclusive, in bitstreams conforming to this edition of this document. Values of {{10}} [[[6]]] to 1023, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of {{10}} [[6]] to {{1023}} [[1203]], inclusive. Values of nnpfc_purpose greater than 1023 shall not be present in bitstreams conforming to this edition of this document and are not reserved for future use.

TABLE 20
Definition of nnpfc_purpose

| Value | Interpretation |
|---|---|
| 0 | May be used as determined by the application |
| 1 | Visual quality improvement{{, without any of chroma upsampling, resolution upsampling, and |
| | picture rate upsampling}} |
| 2 | Chroma upsampling (from the 4:2:0 chroma format to the 4:2:2 or 4:4:4 chroma format, or from the |
| | 4:2:2 chroma format to the 4:4:4 chroma format) |
| 3 | {{Resolution upsampling (increasing}} [[[Increasing]]] the width or height of the cropped decoded |
| | output picture) without {{chroma upsampling and without picture rate upsampling}} [[[changing the |
| | chroma format]]] |
| 4 | {{Resolution upsampling and chroma upsampling, without picture rate upsampling}} [[[Increasing |
| | the width or height of the cropped decoded output picture and upsampling the chroma format]]] |
| 5 | Picture rate upsampling{{, without chroma upsampling and without resolution upsampling |
| 6 | Picture rate upsampling and chroma upsampling, without resolution upsampling |
| 7 | Picture rate upsampling and resolution upsampling, without chroma upsampling |
| 8 | Picture rate upsampling, chroma upsampling, and resolution upsampling |
| 9 | Picture rate upsampling and visual quality improvement, without chroma upsampling and without |
| | resolution upsampling}} |

NOTE 3—When a reserved value of nnpfc_purpose is taken into use in the future by ITU-T|ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 {{, 4, 6, or 8}} [[[or 4]]].

nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

[[[nnpfc_num_input_pics_minus2]]] {{nnpfc_num_input_pics_minus1}} plus [2] {{1}} specifies the number of decoded output pictures used as input for the post-processing filter. {{When nnpfc_purpose is equal to 5, 6, 7, or 8, the value of nnpfc_num_input_pics_minus1 shall be greater than 0.

nnpfc_same_interpolted_pic_num_flag equal to 1 indicates that the number of interpolated pictures between every pair of consecutive input pictures is the same. nnpfc_same_interpolted_pic_num_flag equal to 0 indicates that the number of interpolated pictures between every pair of consecutive input pictures may or may not be the same.

nnpfc_num_interpolated_pics_minus1 plus 1 specifies the number of interpolated pictures between every pair of consecutive input pictures when nnpfc_same_interpolted_pic_num_flag is equal to 1. The value of nnpfc_num_interpolated_pics_minus1 shall be in the range of 0 to 31, inclusive.}}

nnpfc_interpolated_pics[i] specifies the number of interpolated pictures generated by the post-processing filter between the i-th and the (i+1)-th picture used as input for the post-processing filter {{when nnpfc_same_interpolted_pic_num_flag is equal to 0.}}

The variables numInputPics, specifying the number of pictures used as input for the post-processing filter, and numOutputPics, specifying the total number of pictures resulting from the post-processing filter, are derived as follows:

```
{{numInputPics = nnpfc_num_input_pics_minus1 + 1}}
if( nnpfc_purpose = = 5 {{|| nnpfc_purpose = = 6 || nnpfc_purpose = = 7 || nnpfc_purpose = = 8 ||
nnpfc_purpose == 9}} ) {[[[numInputPics = nnpfc_num_input_pics_minus2 + 2]]]
  {{numOutputPics = ( nnpfc_purpose = = 5 ) ? 0: numInputPics}}
  for( i = 0[[[, numOutputPics = 0]]]; i <= numInputPics − 2; i++ ) (76)
    numOutputPics += {{nnpfc_same_interpolted_pic_num_flag ?
      nnpfc_num_interpolated_pics_minus1 + 1 :}} nnpfc_interpolated_pics[ i ]
} else
[[[ numInputPics = 1]]]
  {{numOutputPics = 1}}
```

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 {{, 4, 6, or 8}} [[or 4]], nnpfc_out_order_idc shall not be equal to 3.

Table 22 contains an informative description of nnpfc_out_order_idc values.

TABLE 22
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is 3. |
| 3 | Four luma matrices and two chroma matrices are present in the output tensor, thus the number of |
| | channels is 6. This nnpfc_out_order_idc can only be used when the chroma format is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < {{numOutputPics}} [[[numInputPics]]]; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
  else if( nnpfc_out_order_idc = = 1 ) (83)
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSubWidthC )
          if( Innpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = (yP / outSubHeightC) * outSubHeightC
        xPc = ( xP / outSubWidthC ) * outSubWidthC
        if ( yY < nnpfc_pic_height_in_luma_samples && xY < nnpfc_pic_width_in_luma_samples)
          if( Innpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

### 6.4 Embodiment 4

This embodiment is for the items 1, 5, 6 and some of their subitems summarized above in Section 5.

### 8.28.1 Neural-Network Post-Filter Characteristics SEI Message Syntax

| | Descriptor |
|---|---|
| nn_post_filter_characteristics( payloadSize ) { | |
| ... | |
| nnpfc_purpose | ue(v) |
| /* input and output formatting */ | |
| {{nnpfc_num_input_pics_minus1 | ue(v) |
| if( nnpfc_num_input_pics_minus1 > 0 ) | |
| nnpfc_input_pics_out_idc | u(2)}} |
| if( nnpfc_purpose = = 2 \|\| nnpfc_purpose = = 4 \|\| {{nnpfc_purpose = = 6 \|\| | |
| nnpfc_purpose = = 8 }}) | |
| nnpfc_out_sub_c_flag | u(1) |
| [[[else]]] if( nnpfc_purpose = = 3 \|\| nnpfc_purpose = = 4 \|\| {{nnpfc_purpose = = | |
| 7 \|\| | |
| nnpfc_purpose = = 8 }}) { | |
| nnpfc_pic_width_in_luma_samples | ue(v) |
| nnpfc_pic_height_in_luma_samples | ue(v) |
| } | |
| [[[else]]] if( nnpfc_purpose = = 5 \|\| {{nnpfc_purpose = = 6 \|\| nnpfc_purpose = = | |
| 7 \|\| | |
| nnpfc_purpose = = 8}} ) { | |
| [[[nnpfc_num_input_pics_minus2 | ue(v)]]] |
| for( i = 0; i <= [[[nnpfc_num_input_pics_minus2]]] | |
| {{nnpfc_num_input_pics_minus1 − 1}}; i++ ) | |
| nnpfc_interpolated_pics[ i ] | ue(v) |
| } | |
| ... | |
| } | |

### 8.28.2 Neural-Network Post-Filter Characteristics SEI Message Semantics

nnpfc_purpose indicates the purpose of the post-processing filter as specified in Table 20.

The value of nnpfc_purpose shall be in the range of 0 to {{8}} [[5]], inclusive, in bitstreams conforming to this edition of this document. Values of {{9}} [[6]] to 1023, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of {{9}} [6] to {{1023}} [[1203]], inclusive. Values of nnpfc_purpose greater than 1023 shall not be present in bitstreams conforming to this edition of this document and are not reserved for future use.

TABLE 20
Definition of nnpfc_purpose

| Value | Interpretation |
|---|---|
| 0 | May be used as determined by the application |
| 1 | Visual quality improvement{{, without any of chroma upsampling, resolution upsampling, and |
| | picture rate upsampling}} |
| 2 | Chroma upsampling (from the 4:2:0 chroma format to the 4:2:2 or 4:4:4 chroma format, or from the |
| | 4:2:2 chroma format to the 4:4:4 chroma format) |
| 3 | {{Resolution upsampling (increasing}} [[[Increasing]]] the width or height of the cropped decoded |
| | output picture) without {{chroma upsampling and without picture rate upsampling}} [[[changing the |
| | chroma format]]] |
| 4 | {{Resolution upsampling and chroma upsampling, without picture rate upsampling}} [[[Increasing |
| | the width or height of the cropped decoded output picture and upsampling the chroma format]]] |
| 5 | Picture rate upsampling{{, without chroma upsampling and without resolution upsampling |
| 6 | Picture rate upsampling and chroma upsampling, without resolution upsampling |
| 7 | Picture rate upsampling and resolution upsampling, without chroma upsampling |
| 8 | Picture rate upsampling, chroma upsampling, and resolution upsampling}} |

NOTE 3—When a reserved value of nnpfc_purpose is taken into use in the future by ITU-T|ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 {{, 4, 6, or 8}} [[[or 4]]].

nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

[[[nnpfc_num_input_pics_minus2]]] {{nnpfc_num_input_pics_minus1}} plus [2] {{1}} specifies the number of decoded output pictures used as input for the post-processing filter. {{When nnpfc_purpose is equal to 5, 6, 7, or 8, the value of nnpfc_num_input_pics_minus1 shall be greater than 0.

nnpfc_input_pics_out_idc indicates for which of the input pictures the NNPF generates corresponding output pictures, in addition to generates some output pictures through interpolation when picture rate upsampling is in use. The value 0 indicates that for none of the input pictures the NNPF generates corresponding output pictures. The value 1 indicates that for all the input pictures the NNPF generates corresponding output pictures. The value 2 indicates that for all the input pictures but the first one in output order the NNPF generates corresponding output pictures. The value 3 indicates that for all the input pictures but the last one in output order the NNPF generates corresponding output pictures.

When nnpfc_purpose is equal to 1, 2, 3, or 4, and the value of nnpfc_num_input_pics_minus1 is greater than 0, the value of nnpfc_input_pics_out_idc shall not be equal to 0.}}

In one example, furthermore, when the purpose indicates that no picture upsampling is in use and there are multiple input pictures, it is required that at the value of the indication shall be such that at least one input picture is filtered and output by the NNPF.

nnpfc_interpolated_pics[i] specifies the number of interpolated pictures generated by the post-processing filter between the i-th and the (i+1)-th picture used as input for the post-processing filter.

The variables numInputPics, specifying the number of pictures used as input for the post-processing filter, and numOutputPics, specifying the total number of pictures resulting from the post-processing filter, are derived as follows:

{{ numInputPics = nnpfc_num_input_pics_minus1 + 1
if( numInputPics = = 1 )

numOutputPics = 1

else {

```
if( nnpfc_input_pics_out_idc = = 0 )
  numOutputPics = 0
else if( nnpfc_input_pics_out_idc = = 1 )
  numOutputPics = numInputPics
else if( nnpfc_input_pics_out_idc == 2 )
  numOutputPics = numInputPics − 1}}
```

}
if( nnpfc_purpose = = 5 || {{nnpfc_purpose = = 6 || nnpfc_purpose = = 7 || nnpfc_purpose = = 8}}

| | |
|---|---|
| ) { | [[[numInputPics = nnpfc_num_input_pics_minus2 + 2]]] |
| | for( i = 0, [[[numOutputPics = 0]]]; i <= numInputPics − 2; i++ ) (76) |
| | numOutputPics += nnpfc_interpolated_pics[ i ] |

} [[[else

numInputPics = 1]]]

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 {{, 4, 6, or 8}} [[[or 4]]], nnpfc_out_order_idc shall not be equal to 3.

Table 22 contains an informative description of nnpfc_out_order_idc values.

TABLE 22
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is 3. |
| 3 | Four luma matrices and two chroma matrices are present in the output tensor, thus the number of |
| | channels is 6. This nnpfc_out_order_idc can only be used when the chroma format is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < {{numOutputPics}} [[[numInputPics]]]; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
  else if( nnpfc_out_order_idc = = 1 ) (83)
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = output Tensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = ( xP / outSubWidthC ) * outSubWidthC
        if ( yY < nnpfc_pic_height_in_luma_samples && xY < nnpfc_pic_width_in_luma_samples)
          if( Innpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

The following example process may be used [[[, to filter the cropped decoded output picture patch-wise]]] with the post-processing filter PostProcessingFilter ( ) to generate, {in a patch-wise manner,} the filtered {{and/or interpolated}} picture(s), which contains Y, Cb, and Cr sample arrays FilteredYPic, FilteredCbPic, and FilteredCrPic, respectively, as indicated by nopfc_out_order_idc.

```
if( nnpfc_inp_order_idc = = 0 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 2 )
  for( cTop = 0; cTop < CroppedHeight; cTop += inpPatchHeight) (92)
    for( cLeft = 0; cLeft < CroppedWidth; cLeft += inpPatchWidth) {
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

### 6.5 Embodiment 5

This embodiment is for the invention items 1, 5, 6 and some of their subitems summarized above in Section 5.

### 8.28.1 Neural-Network Post-Filter Characteristics SEI Message Syntax

| | De- |
|---|---|
| | scriptor |
| nn_post_filter_characteristics( payloadSize ) { | |
| ... | |
| nnpfc_purpose | ue(v) |
| /* input and output formatting */ | |
| {{nnpfc_num_input_pics_minus1 | ue(v) |
| if( nnpfc_num_input_pics_minus1 > 0 ) | |
| for( i= 0; i <= nnpfc_num_input_pics_minus1; i++ ) | |
| nnpfc_input_pic_output_flag[ i ] | u(1)}} |
| if( nnpfc_purpose = = 2 \|\| nnpfc_purpose = = 4 \|\| | |
| {{nnpfc_purpose = = 6 \|\| nnpfc_purpose = = 8}} ) | |
| nnpfc_out_sub_c_flag | u(1) |
| [[[else]]] if( nnpfc_purpose = = 3 \|\| nnpfc_purpose = = 4 \|\| | |
| {{nnpfc_purpose = = 7 \|\| | |
| nnpfc_purpose = = 8}} ) { | |
| nnpfc_pic_width_in_luma_samples | ue(v) |
| nnpfc_pic_height_in_luma_samples | ue(v) |
| } | |
| else-if( nnpfc_purpose = = 5 \|\| {{nnpfc_purpose = = 6 \|\| | |
| nnpfc_purpose = = 7 \|\| nnpfc_purpose = = 8}} ) { | |
| [[[nnpfc_num_input_pics_minus2 | ue(v)]]] |
| for( i = 0; i <= [[[nnpfc_num_input_pics_minus2]]] | |
| {{nnpfc_num_input_pics_minus1 − 1}}; i++ ) | |
| nnpfc_interpolated_pics[ i ] | ue(v) |
| } | |
| ... | |
| } | |

### 8.28.2 Neural-Network Post-Filter Characteristics SEI Message Semantics

nnpfc_purpose indicates the purpose of the post-processing filter as specified in Table 20.

The value of nnpfc_purpose shall be in the range of 0 to {{8}} [5], inclusive, in bitstreams conforming to this edition of this document. Values of {{9}} [6] to 1023, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of {{9}} [[6]] to {{1023}} [1203], inclusive. Values of nnpfc_purpose greater than 1023 shall not be present in bitstreams conforming to this edition of this document and are not reserved for future use.

TABLE 20
Definition of nnpfc_purpose

| Value | Interpretation |
|---|---|
| 0 | May be used as determined by the application |
| 1 | Visual quality improvement{{, without any of chroma upsampling, resolution upsampling, and |
| | picture rate upsampling}} |
| 2 | Chroma upsampling (from the 4:2:0 chroma format to the 4:2:2 or 4:4:4 chroma format, or from the |
| | 4:2:2 chroma format to the 4:4:4 chroma format) |
| 3 | {{Resolution upsampling (increasing}} [[[Increasing]]] the width or height of the cropped decoded |
| | output picture) without {{chroma upsampling and without picture rate upsampling}} [[[changing the |
| | chroma format]]] |
| 4 | {{Resolution upsampling and chroma upsampling, without picture rate upsampling}} [[[Increasing |
| | the width or height of the cropped decoded output picture and upsampling the chroma format]]] |
| 5 | Picture rate upsampling{{, without chroma upsampling and without resolution upsampling |
| 6 | Picture rate upsampling and chroma upsampling, without resolution upsampling |
| 7 | Picture rate upsampling and resolution upsampling, without chroma upsampling |
| 8 | Picture rate upsampling, chroma upsampling, and resolution upsampling}} |

NOTE 3—When a reserved value of nnpfc_purpose is taken into use in the future by ITU-T|ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 {{, 4, 6, or 8}} [or 4].

nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

[[[nnpfc_num_input_pics_minus2]]] {{nnpfc_num_input_pics_minus1}} plus [2] {{1}} specifies the number of decoded output pictures used as input for the post-processing filter. {{When nnpfc_purpose is equal to 5, 6, 7, or 8, the value of nnpfc_num_input_pics_minus1 shall be greater than 0.}}

{{nnpfc_input_pic_output_flag [i] equal to 1 indicates that for the i-th input picture the NNPF generates a corresponding output picture. nnpfc_input_pic_output_flag [i] equal to 1 indicates that for the i-th input picture the NNPF does not generate a corresponding output picture.

When nnpfc_purpose is equal to 1, 2, 3, or 4, at least one of nnpfc_input_pic_output_flag [i] for i in the range of 0 to nnpfc_num_input_pics_minus1, inclusive, shall be equal to 1.}}

nnpfc_interpolated_pics[i] specifies the number of interpolated pictures generated by the post-processing filter between the i-th and the (i+1)-th picture used as input for the post-processing filter.

The variables numInputPics, specifying the number of pictures used as input for the post-processing filter, and numOutputPics, specifying the total number of pictures resulting from the post-processing filter, are derived as follows:

```
{{numInputPics = nnpfc_num_input_pics_minus1 + 1
if( numInputPics = = 1 )
  numOutputPics = 1
else
  for( i = 0, numOutputPics = 0; i < numInputPics; i++ )
    if( nnpfc_input_pic_output_flag[ i ] )
      numOutputPics++}}
if( nnpfc_purpose {{= = 5 || nnpfc_purpose = = 6 || nnpfc_purpose = = 7 || nnpfc_purpose = = 8}}
) {[[[numInputPics = nnpfc_num_input_pics_minus2 + 2]]]
  for( i = 0[[[, numOutputPics = 0]]]; i <= numInputPics − 2; i++ ) (76)
    numOutputPics += nnpfc_interpolated_pics[ i ]
} [[[else
  numInputPics = 1]]]
```

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 {{, 4, 6, or 8}} [[or 4]], nnpfc_out_order_idc shall not be equal to 3. Table 22 contains an informative description of nnpfc_out_order_idc values.

TABLE 22
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is 3. |
| 3 | Four luma matrices and two chroma matrices are present in the output tensor, thus the number of |
| | channels is 6. This nnpfc_out_order_idc can only be used when the chroma format is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < {{numOutputPics}} [[[numInputPics]]]; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
  else if( nnpfc_out_order_idc = = 1 ) (83)
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = (xP / outSubWidthC ) * outSubWidthC
        if ( yY < nnpfc_pic_height_in_luma_samples && xY < nnpfc_pic_width_in_luma_samples)
          if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2)
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

The following example process may be used [[[, to filter the cropped decoded output picture patch-wise]]] with the post-processing filter PostProcessingFilter ( ) to generate {{, in a patch-wise manner.}} the filtered {{and/or interpolated}} picture(s), which contains Y, Cb, and Cr sample arrays FilteredYPic, FilteredCbPic, and FilteredCrPic, respectively, as indicated by nnpfc_out_order_idc.

```
if( nnpfc_inp_order_idc = = 0 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 2 )
  for( cTop = 0; cTop < CroppedHeight; cTop += inpPatchHeight) (92)
    for( cLeft = 0; cLeft < CroppedWidth; cLeft += inpPatchWidth) {
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

### 7. References

[1] ITU-T and ISO/IEC. “High efficiency video coding”. Rec. ITU-T H.265|ISO/IEC 23008-2 (in force edition).
[2] J. Chen. E. Alshina. G. J. Sullivan. J. R. Ohm. J. Boyce. “Algorithm description of Joint Exploration Test Model 7 (JEM7).” JVET-G1001. Aug. 2017.
[3] Rec. ITU-T H.266| ISO/IEC 23090-3. “Versatile Video Coding”. 2022.
[4] Rec. ITU-T Rec. H.274| ISO/IEC 23002-7. “Versatile Supplemental Enhancement Information Messages for Coded Video Bitstreams”. 2022.
[5] ISO/IEC JTC 1/SC 29/WG 05 output document NO158, “Text of ISO/IEC 23002-7: 202x (2nd Ed.) DAM 1 Information technology-MPEG video technologies-Part 7: Versatile supplemental enhancement information messages for coded video bitstreams, AMENDMENT 1: Additional SEI messages”, Oct. 2022.
[6] S. McCarthy, T. Chujoh, M. Hannuksela, G. Sullivan, and Y. K. Wang (editors), “Additional SEI messages for VSEI (Draft 3),” JVET output document JVET-AB2006, publicly available online herein: https://www.jvet-experts.org/doc_end_user/current_document.php?id=12215.

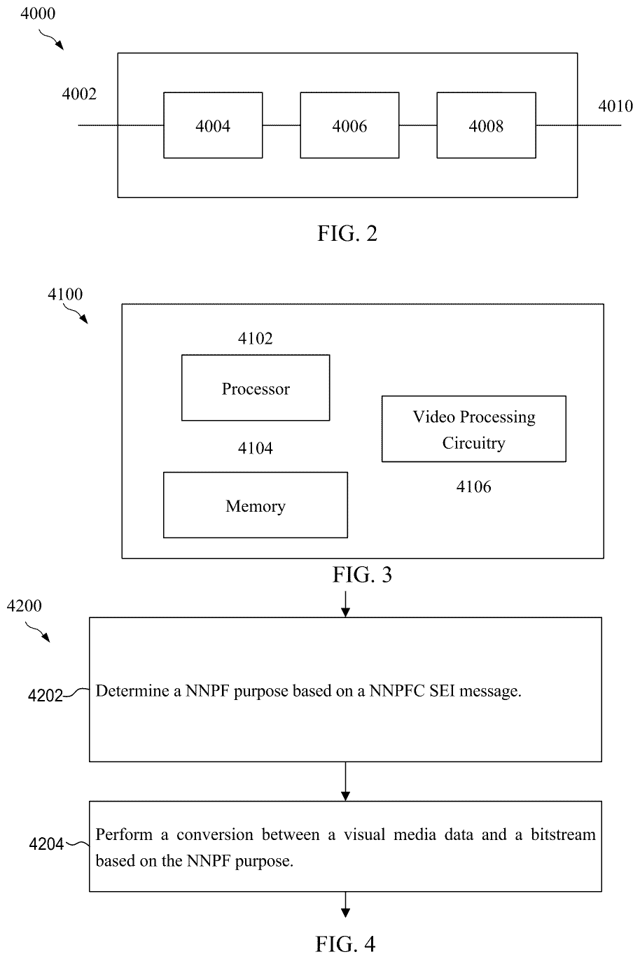

FIG. 2 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 3 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 4 is a flowchart for an example method 4200 of video processing. The method 4200 determines a neural-network post-filter (NNPF) purpose based on a neural-network post-filter characteristics (NNPFC) supplemental enhancement information (SEI) message at step 4202. A conversion is performed between a visual media data and a bitstream based on the NNPF purpose at step 4204.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

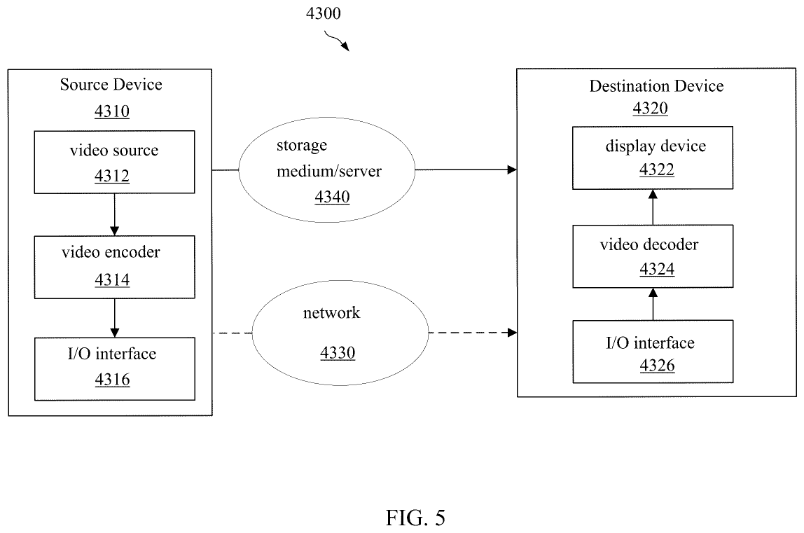

FIG. 5 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the HEVC standard, the VVC standard, and other current and/or further standards.

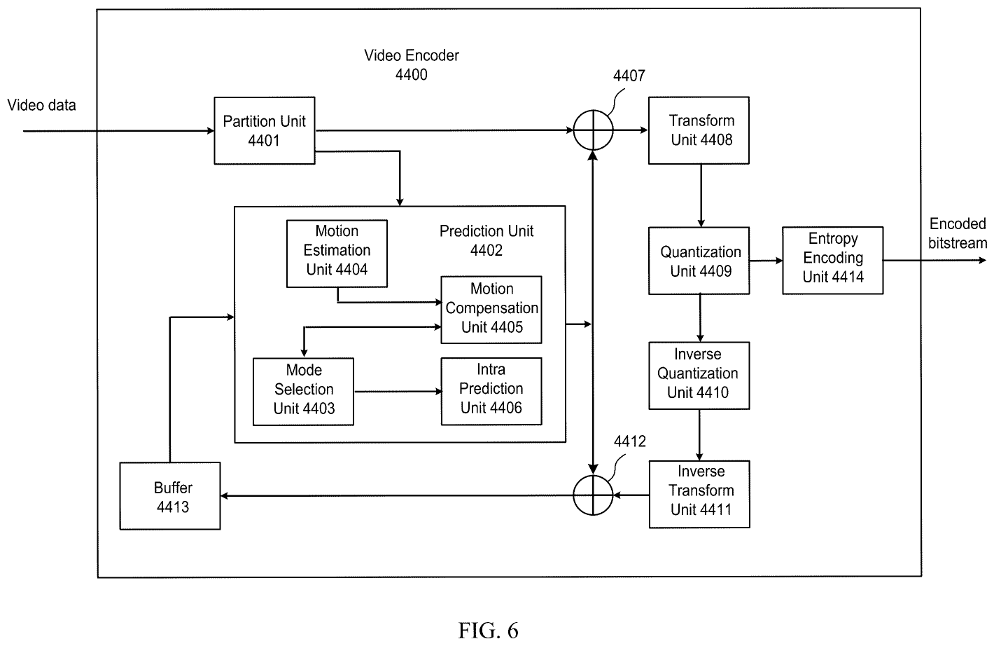

FIG. 6 is a block diagram illustrating an example of video encoder 4400, which may be video encoder 4314 in the system 4300 illustrated in FIG. 5. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

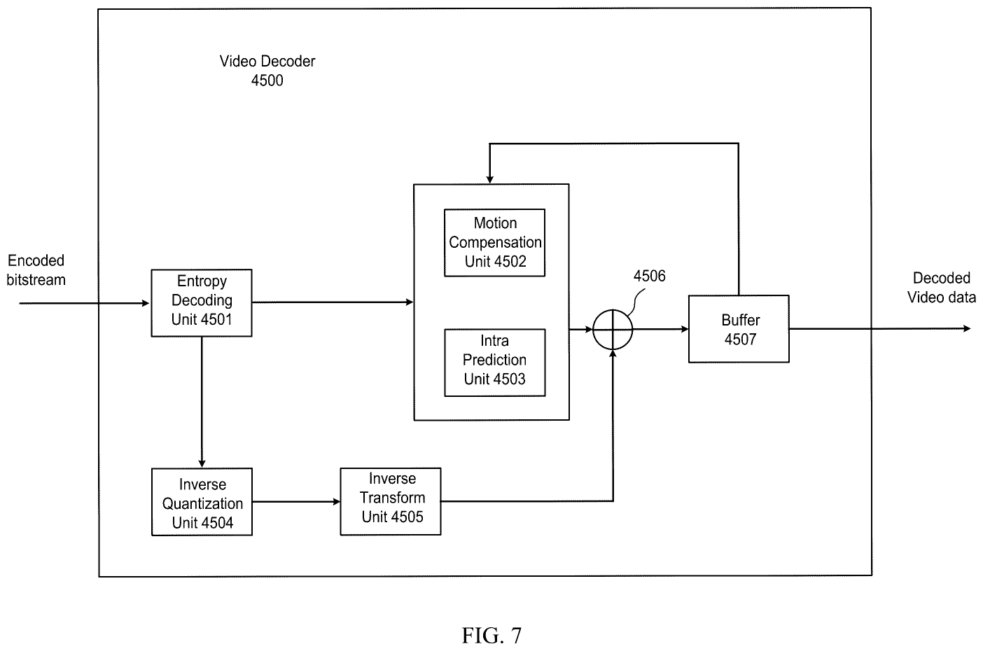

FIG. 7 is a block diagram illustrating an example of video decoder 4500 which may be video decoder 4324 in the system 4300 illustrated in FIG. 5. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

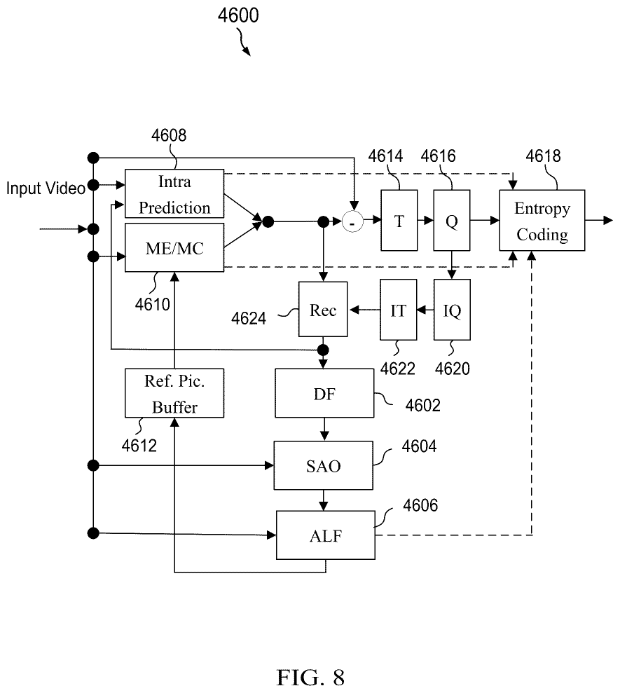

FIG. 8 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.
1. A method for processing media data comprising: determining a neural-network post-filter (NNPF) purpose based on a neural-network post-filter characteristics (NNPFC) supplemental enhancement information (SEI) message; and performing a conversion between a visual media data and a bitstream based on the NNPF purpose.
2. The method of solution 1, wherein the NNPF purpose is picture rate upsampling and chroma upsampling, without resolution upsampling.
3. The method of any of solutions 1-2, wherein the NNPF purpose is picture rate upsampling and resolution upsampling, without chroma upsampling.
4. The method of any of solutions 1-3, wherein the NNPF purpose is picture rate upsampling, resolution upsampling, and chroma upsampling.
5. The method of any of solutions 1-4, wherein the bitstream includes an indication indicating whether a number of interpolated pictures between every pair of consecutive input pictures is the same.
6. The method of any of solutions 1-5, wherein when the indication indicates the number of interpolated pictures between every pair of consecutive input pictures is the same, the bitstream further includes an indication of the number of interpolated pictures between every pair of consecutive input pictures.
7. The method of any of solutions 1-6, wherein the number of interpolated pictures between every pair of consecutive input pictures minus one is included in the bitstream.
8. The method of any of solutions 1-7, wherein the number of interpolated pictures between every pair of consecutive input pictures minus one is restricted to a range of 0 to N, where N is an integer.
9. The method of any of solutions 1-8, wherein N is specified to be 1, 3, 7, 15, 31, or 63.
10. The method of any of solutions 1-9, wherein the bitstream includes an indication indicating whether a fixed output frame rate is constant.
11. The method of any of solutions 1-10, wherein when the number of interpolated pictures between every pair of consecutive input pictures is the same, an indication of an output frame rate is included in the bitstream.
12. The method of any of solutions 1-11, wherein the output frame rate is signaled as the output frame rate minus the input frame rate.
13. The method of any of solutions 1-12, wherein the output frame rate is signaled as a ratio between the output frame rate and an input framerate.
14. The method of any of solutions 1-13, wherein the conversion include a plurality of types of upsampling, and wherein an order of the types of upsampling is determined.
15. The method of any of solutions 1-14, wherein the order of the types of upsampling is indicated in the bitstream.
16. The method of any of solutions 1-15, wherein when both picture rate upsampling and resolution upsampling are performed, picture rate upsampling is performed before resolution upsampling.
17. The method of any of solutions 1-16, wherein when both chroma upsampling and resolution upsampling are performed, chroma upsampling is performed before resolution upsampling.
18. The method of any of solutions 1-17, wherein when both chroma upsampling and picture rate upsampling are performed, picture rate upsampling is performed after chroma upsampling.
19. The method of any of solutions 1-18, wherein the order of the types of upsampling is adaptive based on coding modes or statistics of a corresponding video unit.
20. The method of any of solutions 1-19, wherein the order of the types of upsampling is dependent on a priority of NNPF purposes when multiple types of NNPF are performed.
21. The method of any of solutions 1-20, wherein a number of input pictures is specified for a purpose of visual quality improvement.
22. The method of any of solutions 1-21, wherein a number of input pictures is specified for a purpose of chroma upsampling.
23. The method of any of solutions 1-22, wherein a number of input pictures is specified for a purpose of resolution upsampling.
24. The method of any of solutions 1-23, wherein a number of input pictures is specified for a purpose of chroma upsampling and resolution upsampling.
25. The method of any of solutions 1-24, wherein a number of input pictures minus 1 (nnpfc_num_input_pics_minus1) is signaled, and wherein the number of input pictures (numInputPics) is calculated as: numInputPics=nnpfc_num_input_pics_minus1+1.
26. The method of any of solutions 1-25, wherein the number of input pictures is signaled for each frame.
27. The method of any of solutions 1-26, wherein pictures used as input for NNPF purposes are applied according to a rule, and wherein the rule indicates the pictures used as input for NNPF purposes depend on coding modes of a video unit, are predefined, or are signaled.
28. An apparatus for processing video data comprising: a processor; and a non-transitory memory with instructions thereon, wherein the instructions upon execution by the processor, cause the processor to perform the method of any of solutions 1-27.
29. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-27.
30. A non-transitory computer-readable recording medium storing a bitstream of a video which is generated by a method performed by a video processing apparatus, wherein the method comprises: determining a neural-network post-filter (NNPF) purpose based on a neural-network post-filter characteristics (NNPFC) supplemental enhancement information (SEI) message; and generating a bitstream based on the determining.
31. A method for storing bitstream of a video comprising: determining a neural-network post-filter (NNPF) purpose based on a neural-network post-filter characteristics (NNPFC) supplemental enhancement information (SEI) message; generating a bitstream based on the determining; and storing the bitstream in a non-transitory computer-readable recording medium.
32. A method, apparatus or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining an indication for a current input picture used for a neural-network post-filter (NNPF) based on a neural-network post-filter characteristics (NNPFC) supplemental enhancement information (SEI) message, wherein the indication for the current input picture indicates that for the current input picture, whether the NNPF generates a corresponding output picture; and
performing a conversion between the media data and a bitstream based on the indication,
wherein whether the indication is included in the bitstream depends on a number of pictures used as input for the NNPF.

2. The method of claim 1, wherein when the number of pictures used as input for the NNPF is greater than 1, the indication for each of the pictures used as input for the NNPF is included in the NNPFC SEI message.

3. The method of claim 1, wherein when a purpose of the NNPF includes picture rate upsampling, the indication for each of the pictures used as input for the NNPF is included in the NNPFC SEI message.

4. The method of claim 1, wherein when a purpose of the NNPF does not include picture rate upsampling and the number of pictures used as input for the NNPF is greater than 1, for at least one input picture among the pictures used as input for the NNPF, the NNPF generates a corresponding output picture.

5. The method of claim 1, wherein when a purpose of the NNPF does not include picture rate upsampling and the number of pictures used as input for the NNPF is greater than 1, the indication for at least one input picture among the pictures used as input for the NNPF has a first value.

6. The method of claim 5, wherein the indication for the at least one input picture having the first value indicates that for the at least one input picture, the NNPF generates a corresponding output picture.

7. The method of claim 5, wherein the first value is equal to 1.

8. The method of claim 1, wherein when the indication for the current input picture has a first value, the indication indicates that for the current input picture, the NNPF generates the corresponding output picture.

9. The method of claim 1, wherein when the indication for the current input picture has a second value, the indication indicates that for the current input picture, the NNPF does not generate the corresponding output picture.

10. The method of claim 1, wherein the indication is coded with an unsigned integer using one bit.

11. The method of claim 1, wherein when the number of pictures used as input for the NNPF is equal to 2, a first input picture and a second input picture are used for the NNPF, and the indication for the first input picture and the indication for the second input picture are both included in the NNPFC SEI message.

12. The method of claim 1, wherein the conversion includes encoding the media data into the bitstream.

13. The method of claim 1, wherein the conversion includes decoding the media data from the bitstream.

14. An apparatus for processing media data comprising: a processor; and a non-transitory memory with instructions thereon, wherein the instructions upon execution by the processor, cause the processor to:
determine an indication for a current input picture used for a neural-network post-filter (NNPF), based on a neural-network post-filter characteristics (NNPFC) supplemental enhancement information (SEI) message, wherein the indication for the current input picture indicates that for the current input picture, whether the NNPF generates a corresponding output picture; and
perform a conversion between the media data and a bitstream based on the indication,
wherein whether the indication is included in the bitstream depends on a number of pictures used as input for the NNPF.

15. The apparatus of claim 14, wherein when the number of pictures used as input for the NNPF is greater than 1, the indication for each of the pictures used as input for the NNPF is included in the NNPFC SEI message.

16. The apparatus of claim 14, wherein when a purpose of the NNPF includes picture rate upsampling, the indication for each of the pictures used as input for the NNPF is included in the NNPFC SEI message.

17. A non-transitory computer-readable storage medium storing instructions that cause a processor to:
determine an indication for a current input picture used for a neural-network post-filter (NNPF), based on a neural-network post-filter characteristics (NNPFC) supplemental enhancement information (SEI) message, wherein the indication for the current input picture indicates that for the current input picture, whether the NNPF generates a corresponding output picture; and
perform a conversion between media data and a bitstream based on the indication,
wherein whether the indication is included in the bitstream depends on a number of pictures used as input for the NNPF.

18. The non-transitory computer-readable storage medium of claim 17, wherein when the number of pictures used as input for the NNPF is greater than 1, the indication for each of the pictures used as input for the NNPF is included in the NNPFC SEI message.

19. A non-transitory computer-readable recording medium storing a bitstream which is generated by a method performed by a video processing apparatus, wherein the method comprises:
determining an indication for a current input picture used for a neural-network post-filter (NNPF), based on a neural-network post-filter characteristics (NNPFC) supplemental enhancement information (SEI) message, wherein the indication for the current input picture indicates that for the current input picture, whether the NNPF generates a corresponding output picture; and
generating the bitstream based on the indication.

20. The non-transitory computer-readable recording medium of claim 19, wherein when a number of pictures used as input for the NNPF is greater than 1, the indication for each of the pictures used as input for the NNPF is included in the NNPFC SEI message.
